(19) United States
(12) Patent Application Publication
(10) Pub. No.: US 2002/0198817 A1
(43) Pub. Date: Dec. 26, 2002

(54) Method and apparatus for trading assets, capital, and information

(76) Inventor: Rahul Dhir, London (GB)

Correspondence Address: BAKER & BOTTS, 30 ROCKEFELLER PLAZA, NEW YORK, NY, 10112

(21) Appl. No.: 10/094,111

(22) Filed: Mar. 8, 2002

Related U.S. Application Data
(60) Provisional application No. 60/274,135, filed on Mar. 8, 2001.

(51) Int. Cl. G06F 17/60

(52) U.S. Cl. 705/37

(57) ABSTRACT

A secure, open, independent, collaborative on-line platform is provided for trading assets, accessing capital, and managing information. The platform can support, for example, asset trading, provision of capital and risk management services, delivery of decision support tools, and applications for service subscribers in the oil and gas industry. The system can provide a secure infrastructure to facilitate sharing of information among oil and gas companies and financial institutions, resulting in a more efficient market for assets and asset-related financial products.

### CROSS-REFERENCE TO RELATED APPLICATION

This application claims priority to U.S. Provisional Patent Application No. 60/274,135, entitled “Method and Apparatus for Trading Assets, Capital, and Information,” filed on Mar. 8, 2001, which is incorporated herein by reference in its entirety.

### FIELD OF THE INVENTION

The present invention relates generally to the exchange of assets, capital, and information, and more particularly to methods and systems for exchanging assets, capital, and information using communications systems.

### BACKGROUND OF THE INVENTION

Asset trading in the oil and gas industry is a core business process for certain entities, particularly for upstream oil and gas companies seeking to restructure and optimize their portfolios. Each year, over 600 publicly disclosed transactions are completed, which totals an estimated $20-$40 billion per year (all dollar amounts herein are in U.S. dollars). It is therefore important for the asset trading process to be efficient. However, each transaction, whether large or small, is currently structured in a customized manner and is generally not performed by using digital or electronic information. Consequently, the transaction process is time consuming and expensive, and the asset market may be illiquid and opaque.

The oil and gas industry is also highly capital intensive; estimates suggest that during the years 1997 to 2000, an average of over $150 billion of capital has been raised annually in the commercial bank market for the oil and gas business. This includes capital raised to fund acquisitions and development projects (i.e., asset-based financing), working capital, and general corporate purposes. The asset-based financing market represents approximately $70 billion per year. During the years 1997 to 2000, approximately 36% of the total asset-based financial market, or $55 billion per year, was raised to finance acquisitions, and 8% of the total asset-based financial market, or $12 billion, was raised to finance projects.

The market for commodity risk management products is also substantial. The following estimates have been made with respect to the 1999 worldwide traded volumes for natural gas, West Texas Intermediate Crude (WTI), International Petroleum Exchange Brent Crude (IPE Brent), and the respective proportions and notional values (i.e., the values of the volumes underlying the risk management contracts) of risk management services for each commodity:

| | | | Notional Value, |
|---|---|---|---|
| | | | $ bn (Based on a |
| | | Risk | notional value of $ |
| | | Management | 2.50/MMBtu for gas |
| Commodity | Volume | (%) | and $20/bbl for oil) |
| Natural gas | 360Bn MMBtu | 20 | 180 |
| (US & UK) | | | |
| WTI | 40Bn bbls | 10 | 80 |
| IPE Brent | 15Bn bbls | 10 | 30 |

The expectation is that the trading in each of these benchmark commodities shall continue to grow at about 5% a year for the foreseeable future, based on estimates of forward volumes for the next two years. However, there is currently limited access to financial services for asset trading. As a result, the market for asset-linked financing and commodity risk management is inefficient.

An important part of the asset trading and capital raising processes is access to decision support services. In fact, the market for global Decision Support Services and Application Service Providers (“ASPs”) could total $8 billion by the year 2004. The market for content and geo-technical applications for the upstream oil and gas industry alone is worth approximately $2 billion per year. Major software and content providers in the upstream oil and gas industry are developing ASP models in which their products and services are delivered on a fee-per-use basis, rather than under a one-time license. However, reaching and managing customers is one of the key challenges. In addition, users of the decision support services often face a bewildering range of choices regarding the content, research, analytical tools, and geo-technical software, partly because there is a large number of decision support service providers in the market. The users are often unable to access the relevant tools at the right time or in the proper context. Furthermore, there is insufficient competition in the exchange of assets, capital, and information, as well as in the provision of services supporting such trading.

The commodity pricing environment is also very volatile, and therefore the market for risk management products is significant. In 1999, the notional value of the commodity trading related to the risk management (based on key benchmark commodities) was in excess of $290 billion.

However, the market for the asset-linked financing and commodity risk-management services is currently inefficient. Smaller companies have limited access to the capital and relevant risk management products. In addition, the suppliers of the capital and risk-management services are usually not fully integrated into the decision making process. This problem is particularly pervasive with respect to acquisitions and divestitures for which the need for quick decision-making leaves insufficient time for the suppliers of the services to be fully integrated into the process.

Furthermore, most vendors are finding it difficult to persuade their customers to adopt web-based delivery and pay-per-use systems.

### SUMMARY OF THE INVENTION

Accordingly, there is a need to streamline the acquisitions and divestiture process, thereby making it easier for companies to buy, sell, farm in, farm out, or swap assets. Such streamlining of the process will give the companies an improved ability to extract value from their portfolios at multiple points of liquidity.

It is therefore one of the objects of the present invention to provide a web-based application which can deliver context-based content and decision support applications with an integrated billing system, using an interface which is familiar to a user.

It is a further object of the present invention to provide a complete on-line transaction execution and management service. The service can include related financial and information services.

It is another object of the present invention to create a liquid and transparent marketplace for trading ownership interests in oil and gas fields.

Some of the advantages of the present invention are:

Increased liquidity of trading;

A trading environment administered by a neutral party;

Provision of information and tools in close proximity to the buy/sell decisions; and

Ability to build on users' trust, and brand-recognition, of reputable financial institutions in order to enhance the users' trust of the system.

These and other objects of the invention are achieved by the provision of a method and apparatus for providing an exchange service.

In accordance with a first preferred embodiment of the present invention, there is provided a method for providing an exchange service, comprising the steps of: (1) providing an asset exchange service configured to transmit, using a network, asset-related information between a first party and a second party, the first party including at least one of a first potential asset transferor and a first potential asset transferee, and the second party including at least one of a second potential asset transferor and a second potential asset transferee; and (2) providing a finance exchange service configured to enable at least one of the first party and the second party to at least one of: (a) negotiate for at least one financing-related transaction with at least one financial institution; and (b) execute the at least one financing-related transaction.

In accordance with a second preferred embodiment of the invention, there is provided a method for providing a digital document, comprising the steps of: (1) receiving at least one asset-related document in human-readable form at at least one scanning location, wherein the at least one asset-related document is previously transported from an on-site location to the at least one scanning location; (2) optically scanning the at least one asset-related document at the at least one scanning location, to generate at least one digital document; and (3) storing the at least one digital document in a computer system which in communication with a network, wherein the computer system is configured to transmit the at least one digital document through the network to at least one party upon a command of the at least one party.

In accordance with a third preferred embodiment of the present invention, there is provided an apparatus for providing an exchange service, comprising a processor controlled by a set of instructions which directs the processor to: (1) provide an asset exchange service configured to transmit, using a network, asset-related information between a first party and a second party, the first party including at least one of a first potential asset transferor and a first potential asset transferee, and the second party including at least one of a second potential asset transferor and a second potential asset transferee; and (2) provide a finance exchange service configured to enable at least one of the first party and the second party to at least one of: (a) negotiate for at least one financing-related transaction with at least one financial institution; and (b) execute the at least one financing-related transaction.

In accordance with a fourth preferred embodiment of the invention, there is provided an arrangement for providing a digital document, comprising: (1) a scanner which is provided at a scanning location and which is suitable for optically scanning at least one asset-related document, in human-readable form, to generate at least one digital document, wherein the at least one asset-related document is previously transported from an on-site location to the scanning location; and (2) a computer system in communication with the scanner and a network, the computer system comprising a processor which: (a) receives the at least one digital document from the scanner, and (b) transmits the at least one digital document via the network to at least one party upon a request of the at least one party.

### BRIEF DESCRIPTION OF THE DRAWINGS

Further objects, features, and advantages of the present invention will become apparent from the following detailed description taken in conjunction with the accompanying figures showing illustrative embodiments of the present invention, in which:

FIG. 1 is a diagram illustrating an exemplary procedure for engaging in an asset transaction in accordance with the present invention;

FIG. 2 is a diagram illustrating an exemplary procedure for transporting and scanning documents in accordance with the present invention;

FIG. 3 is a diagram illustrating an exemplary procedure for engaging in a financial transaction in accordance with the present invention;

FIG. 4 is a diagram illustrating an additional exemplary procedure for engaging in a financial transaction in accordance with the present invention;

FIG. 5 is a diagram illustrating an additional exemplary procedure for engaging in a financial transaction in accordance with the present invention;

FIG. 6 is a diagram illustrating use of an exemplary virtual private network (“VPN”) in accordance with the present invention;

FIG. 7 is a diagram illustrating an exemplary procedure for using a set of services in accordance with the present invention;

FIG. 8 is a diagram illustrating an exemplary log-on screen in accordance with the present invention;

FIG. 9 is a diagram illustrating an exemplary home page in accordance with the present invention;

FIG. 10 is a diagram illustrating an exemplary display of a news item in accordance with the present invention;

FIG. 11 is a diagram illustrating an exemplary display for an asset exchange in accordance with the present invention;

FIG. 12 is a diagram illustrating an exemplary display for a research library in accordance with the present invention;

FIG. 13 is a diagram illustrating an additional exemplary display for a research library in accordance with the present invention;

FIG. 14 is a diagram illustrating an exemplary display of a research report in accordance with the present invention;

FIG. 15 is a diagram illustrating an exemplary display of a regional activity update in accordance with the present invention;

FIG. 16 is a diagram illustrating an exemplary display of a financing proposal in accordance with the present invention;

FIG. 17 is a diagram illustrating an exemplary display for a finance exchange in accordance with the present invention;

FIG. 18 is a diagram illustrating use of an exemplary communications hub in accordance with the present invention;

FIG. 19 is a diagram illustrating exemplary displays of information obtained through an information exchange in accordance with the present invention;

FIG. 20 is a diagram illustrating an additional exemplary display for an asset exchange in accordance with the present invention;

FIG. 21 is a diagram illustrating an exemplary display for a bidding interface in accordance with the present invention;

FIG. 22 is a diagram illustrating a further exemplary display for an asset exchange in accordance with the present invention;

FIG. 23 is a diagram illustrating another exemplary display for an asset exchange in accordance with the present invention;

FIG. 24 is a diagram illustrating an exemplary display for a virtual workspace in accordance with the present invention;

FIG. 25 is a diagram illustrating another exemplary display for a virtual workspace in accordance with the present invention;

FIG. 26 is a diagram illustrating yet another exemplary display for a virtual workspace in accordance with the present invention;

FIG. 27 is a diagram illustrating still another exemplary display for a virtual workspace in accordance with the present invention;

FIG. 28 is a diagram illustrating an exemplary landing page in accordance with the present invention;

FIG. 29 is a diagram illustrating an exemplary computer system in accordance with the present invention; and

FIG. 30 is a block diagram illustrating an exemplary processing arrangement of the computer system of FIG. 29.

### DETAILED DESCRIPTION OF PREFERRED EMBODIMENTS

In accordance with the present invention, an electronic communications system can be configured to provide computer-based (e.g., network-based) asset trading, capital and risk management services, as well as decision support tools and applications for participants in the oil and gas industries, among others. Users can subscribe to a comprehensive service which can include some or all of the aforementioned services. Because the various services are provided in close proximity to each other, and in an easily accessible manner, the trading of assets, capital, and information can be easier, faster, and more efficient. Various embodiments of these services are described in further detail below.

In accordance with one aspect of the present invention, an electronic system can provide an “asset exchange” comprising an independent and secure environment for effective asset and knowledge management. The asset exchange preferably serves as a marketplace for trading oil and gas assets and services. Such trading can include, for example, buying, selling, swapping (i.e., bartering), or otherwise transferring interests in various assets. Assets traded on the exchange can include, for example, equity and/or ownership interests in real estate from which oil, gas, other mineral resources, or other natural resources can be harvested. The term “real estate,” as used herein, includes a geographical territory on either land or water. Assets traded on the exchange can also include interests in companies such as, for example, oil and gas companies. The exchange can be used for mergers (e.g., corporate mergers), acquisitions, divestitures disposals, exploration services, swaps, farm-ins, farm-outs, etc. In addition to listing the assets for swap (i.e., barter) or sale, the exchange can optionally include complete transaction execution and management. The assets can be bought, sold, swapped, or otherwise transferred, either directly or by an auction. The asset exchange is particularly advantageous for asset transactions smaller than $200 million. The system can facilitate inter-company and intra-company flows of information and knowledge. In order to implement the system, a technical infrastructure is preferably provided. This infrastructure can include the following:

A system for managing and executing transactions via a communications network (e.g., the Internet, an intranet, or a modem connection);

An “open” and secure, dedicated collaboration network that links oil companies and other organizations, e.g., service companies, consultants, application service providers, and financial institutions; and

A platform for the delivery, to upstream professionals, of integrated decision support tools and services.

The system of the present invention can enable companies to buy, sell, farm in, farm out, or swap assets. Participants have the ability to extract value from an asset, not only when it is in its production stage, but at multiple points of liquidity—in particular, at multiple stages in the life cycle of the asset. For example, asset value can be realized whether the asset is: (1) being used solely for exploration, (2) being appraised, (3) under development, (4) productive, or (5) nearing the end of its production life. Such liquidity allows for a rapid portfolio realignment and results in a more realistic portfolio valuation. These benefits can have a profound impact on how companies manage their asset portfolios and realize value from the respective assets for their shareholders.

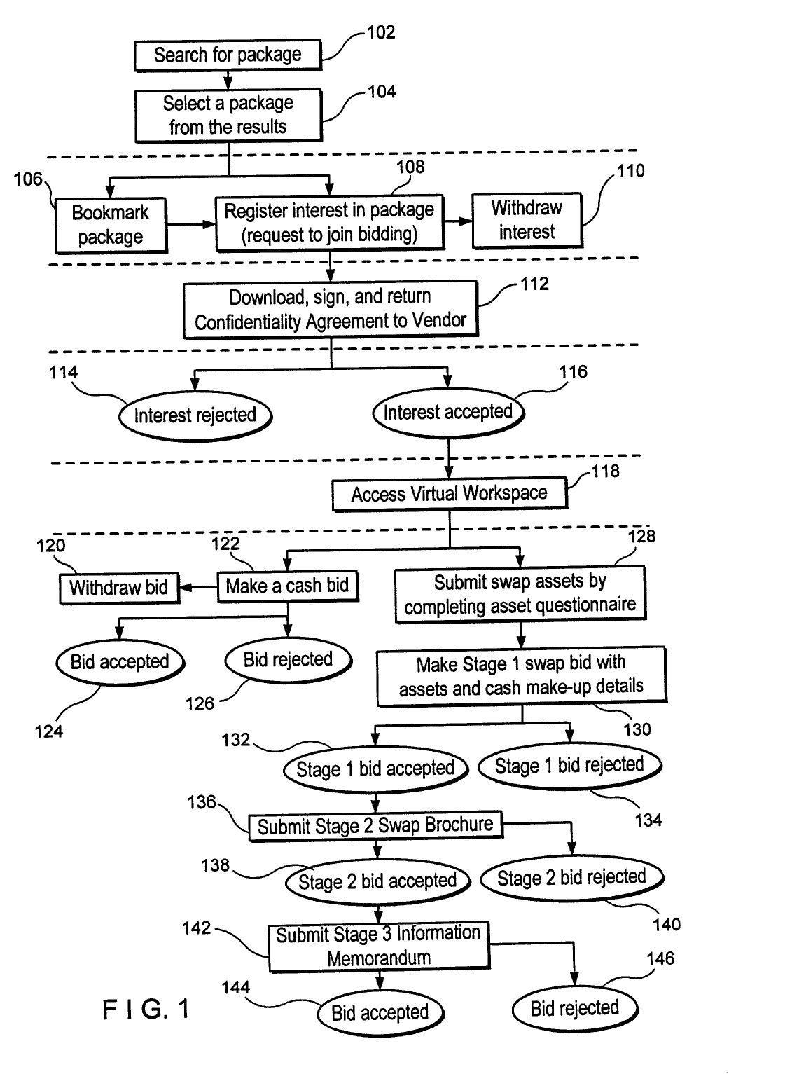

FIG. 1 illustrates an exemplary procedure by which a user of the asset exchange can purchase, or attempt to purchase, an asset using a bidding process. The user first searches for an asset package that a potential seller has posted on the asset exchange (step 102). An asset package can include a single asset or a set of assets grouped together for sale or swap. An asset can include an equity interest in an oil and/or gas field, in a block of geographic territory containing oil and/or gas fields or portions thereof, or in a license to harvest at least one resource from such a field or block of territory. The user then selects a particular package from the results he or she has obtained (step 104). The user can optionally bookmark the particular package to be considered at a later point (step 106). Regardless of whether he or she has bookmarked the package, the user can register the user's interest in the package by making a request to join the bidding process for the package (step 108). Optionally, the exchange can be configured to enable the potential seller to store information regarding the number of users who have registered their interest in the package. If the user decides that he is no longer interested in the package, he or she may withdraw from the bidding process (step 110). If the user decides to continue the bidding process, he or she then downloads and signs (e.g., using a digital signature) a confidentiality agreement, and returns the “signed” agreement to the vendor (i.e., the potential seller) of the package (step 112). The vendor has the option of rejecting the user's interest (step 114) or accepting the user's interest (step 116). If the vendor accepts the user's interest, the user then (in step 118) enters a “virtual workspace”—as described in further detail below—from which he or she can make a cash bid (step 122) or initiate a swap-type bid (step 128). In the case of a cash bid, the user has the option to withdraw his or her bid before it is accepted by the vendor (step 120). If the user does not withdraw his or her bid, the vendor has the option of accepting the user's bid (step 124) or rejecting the bid (step 126).

If the bid is for a swap-type transaction, information regarding which assets are to be swapped can be conveyed by the user's completion of an asset questionnaire (step 128). The user can then make a Stage 1 swap bid (step 130) specifying details such as which assets are to be swapped and how much cash will be included in the deal. The recipient of the bid (a second swapper) can either accept the Stage 1 bid (step 132) or reject the bid (step 134). If the bid is accepted, the user submits a Stage 2 bid (step 136) which includes a “swap memorandum” (a/k/a a “swap brochure” or a “swapper's brochure”) containing important information about the asset that the user is offering to swap. This brochure is discussed in further detail below.

Upon receiving the Stage 2 bid, the second swapper can either accept this bid (step 138) or reject it (step 140). If the Stage 2 bid is accepted, the user submits a Stage 3 information memorandum containing any additional information which is required (step 142). The second swapper then has a final opportunity either to abort the process by rejecting the bid (step 146), or to complete the deal by conclusively accepting the bid (step 144).

The swapper's memorandum should preferably contain cost, production, commercial, and tax information for developing a post-tax cash flow analysis of the asset(s) based on the mean reserves level—i.e., based on the expected value of the reserves of the asset. Preferably, the reserve spectrum can also be presented. In particular, the memorandum can include information on “proven” reserves (e.g., reserves associated with a 90% probability of existence, a/k/a “P90 reserves”), “probable” reserves (e.g., reserves associated with a 50% probability, a/k/a “P50 reserves”), and/or “possible” reserves (e.g., reserves associated with a 10% probability, a/k/a “P10 reserves”). Furthermore, depending on the life cycle of the asset(s) being offered, additional information should also be presented in the brochure in order to enable the assessment of risk and value of the proposed transaction. The brochure preferably has the same general format and content as a typical information memorandum, although narrative text and figures can be kept to a minimum. The document is preferably written in a summary note form, concentrating on the numbers, tables, and concepts which may be necessary for understanding the asset(s) and quantifying its value.

The brochure can also include an introduction which can provide, for example, the following information about the asset:

* country

region

license status

block names and numbers

water depth

main horizon objectives

license terms summary

ownership history

equities

redetermination schedule

regional maps for context and detail

Additionally, the brochure can include geology and geophysics (“G&G”) information such as the following:

brief exploration history

geological setting

structural map and cross-section/seismic line

brief drilling history

reservoir description (petrophysical rock properties, fluid properties)

future workplans

The brochure can further include information regarding the reserves potential of the asset, such as a make-up for geological risk forecast and discussion, which can address, e.g.:

structure percentage

seal percentage

reservoir percentage

source percentage

parameter average ranges for derivation of fluids in place (gross rock volume,

net to gross ratio, porosity, water saturation, fluid shrinkage, etc.)

a discussion of reservoir/prospect fluids initially in place and reserves (P90, P50, P10, mean) for all fluids oil, condensate, natural gas liquids (“NGLs”), gas

a discussion of the basis and source of derivation of data and reserves (analogy, operator, simulation, material balance, and other)

present production history for each reservoir (if any)

The brochure can additionally include a section on development (or potential development options if an appraisal/exploration is needed). This section can have discussions of:

a development scheme

product exports route options

local infrastructure (such as roads, electricity, gas, rivers, water sources, environment, etc.)

general facilities layout

process specification

wells status and integrity (e.g., whether abandoned or suspended)

future well requirements forecast

production forecast table based on probabilistic or deterministic estimates, as appropriate (P90, P50, P10, mean)

discussion of the basis of derivation of the production forecasts

future workplans

Also included in this brochure can be a commercial and legal section. This section can provide:

major equipment lease/contract terms (e.g., rig contracts)

summary of voting rights for expenditure approvals, as set forth in a joint operating agreement (“JOA”)

information on wells

new developments

budgets

vetoes

summary of significant commercial agreements (power import, gas purchase, sales, export tariffs/tolls, etc.) as related to the cost forecasts

preemption summary

In addition, the brochure can include a financial and tax section. This section can include:

a forecast of capital and operating costs by category (including current year budget, basis of derivation, source currency, etc.)

a summary of historic costs to date, by major category

a control budget (if any) for development project capital costs

a life of field cost forecast, if available, with stated assumptions for throughput dependency

a brought-forward tax position for all relevant tax allowances and liabilities

In addition to executing transactions using bidding processes, the participants can transfer assets by a direct negotiation and/or sale. For example, the owner of an asset can offer the asset for sale on the asset exchange, and the exchange can be configured to enable another participant to execute a purchase by accepting the offer. Furthermore, a potential purchaser can make an offer to buy an asset listed on the exchange, and the exchange can be configured to enable the owner of the asset to execute a sale by accepting the offer.

In accordance with an advantageous embodiment of the present invention, an optical scanner can be utilized to scan documents related to a particular asset to be listed on the asset exchange. The scanned documents can include, for example, technical documents describing physical characteristics or other attributes of the asset, and legal and financial documents related to legal and financial characteristics (such as the financial status of the asset, the ownership of the asset, security interests in the asset, and the monetary value of the asset). The scanned documents can also include other documents which may be of interest to participants in the asset exchange. Optionally, the documents related to one or more assets may be scanned either at a central location or at multiple scanning locations provided at the central location or remote therefrom. Often, documents related to an asset are in “hard copy” (or human-readable) form, and are stored “on-site”—i.e., at the location of the asset itself—in which case it may be advantageous to utilize one or more couriers to deliver the documents to one or more scanning locations. For example, if technical and legal documents related to several oil and gas fields are maintained at the locations of the respective oil and gas fields, it may be desirable to utilize couriers to deliver the documents from the respective oil and gas fields to a central scanning location, where the documents can be scanned so as to create digital documents which can be made available for download from the asset exchange.

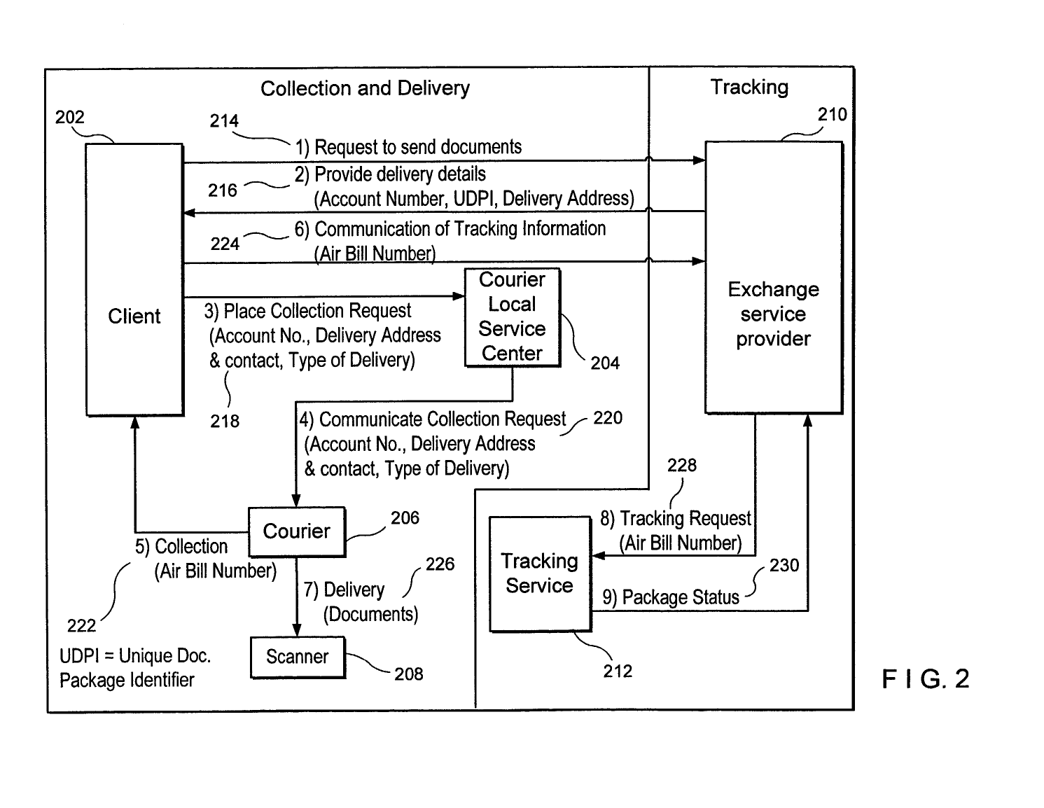

An exemplary procedure for delivering and scanning documents is illustrated in FIG. 2. In this procedure, a client 202 may wish to list an asset for sale or swap on the asset exchange, which is administered by an exchange service provider 210. The client can be assigned to a client coordinator who can serve as the client's contact person at the exchange service provider 210. The client 202 contacts its client coordinator at the exchange service provider 210 and expresses an interest in registering an asset. This communication may be followed by discussions that ultimately result in an “A-listing” of documents that the client 202 would like to publish in its electronic data room. Such an A-listing can preferably include selected documents that most visitors interested in the asset would likely wish to view. The selected documents can be made available in a data room and/or virtual workspace associated with the asset. In some cases, the vendor may also possess additional documents related to the asset, which might not be of sufficiently widespread interest to justify their inclusion in the A-listing. Once the A-listing has been established, the client makes a request 214 to send in its documentation for scanning. This request 214 is communicated to the client coordinator by telephone, e-mail or other electronic or manual means.

Upon the receipt of the request 214, the client coordinator makes a reply 216 to the client by providing the client with the following courier and delivery information, which can be communicated to the client in the form of an e-mail 216:

| Ref | Field Name | Description | Exemplary Values |
|---|---|---|---|
| 1 | Account Number | The exchange service provider's account | 9613XXXXX |
| | | number with a courier service. | |
| 2 | UDPI | This is a unique identifier established by | STLON01 |
| | | the exchange service provider to link the | |
| | | documentation (A-list) to the package/ | |
| | | asset already set up on the asset exchange. | |
| 3 | Delivery | The address including the specific | Williams Lea |
| | Address | department to which the documents should | Clifton House |
| | | be delivered. | Worship Street |
| | | | London |
| | | | EC2A 2EJ |
| 4 | Delivery Contact | The contact name and telephone number. | Dan Murdoch |
| | | | +44 207 772 |
| | | | 4673 |
| 5 | Local Courier | The telephone number of the courier | DHL Manhattan |
| | Service Center | service center closest to the Client. | New York City |
| | | | +01 7563 99090 |

The client 202 then contacts its local courier service center and requests a collection message 218). The client is asked to supply the following details to the courier service center 204:

| Ref | Field Name | Description | Exemplary Values |
|---|---|---|---|
| 1 | Account Number | The exchange service provider's account | 9613XXXXX |
| | | number with the courier. | |
| 2 | Collection | Details of a contact at the client that will | Joe Soap |
| | | be responsible for dispatching the | Mail Room |
| | Contact | documents. | Manager |
| | | | +01 212 321424 |
| 3 | Collection Time | The time that the client would like the | 5th of September |
| | | documents collected. | Afternoon. |
| 4 | Collection | The Client's address and the specific | Mail Room |
| | Address | department in which the documents will | MSDW |
| | | reside, e.g., Mail room. | 212 Broadway |
| | | | NYC, NY, 1038 |
| 5 | UDPI | As provided by the Client Coordinator in | STLON01 |
| | | the Delivery Details memo. | |
| 6 | Delivery | As provided by the Client Coordinator in | Williams Lea |
| | Address | the Delivery Details memo. | Clifton House |
| | | | Worship Street |
| | | | London |
| | | | EC2A 2EJ |
| 7 | Delivery Contact | As provided by the Client Coordinator in | Dan Murdoch |
| | | the Delivery Details memo. | +44 207 772 4673 |
| 8 | Delivery | [070] Box Request (Size and Number) | 3 × Boxes |
| | Instruction | [071] Request for air bill | Air bill |
| | | [072] Specify the delivery type as | DOX |
| | | Documents = DOX | |

The courier local service center 204 then communicates the collection request to the courier 206 (message 220). The courier 206 records the collection address and contact details onto an air bill, and proceeds to collect the documents.

The courier 206, on the instructions of the courier local service center 204, then proceeds to the premises of the client 202 to collect the documents (step 222). At the premises of the client 202, the courier 206 completes the air bill (including the number of packages and any other delivery instructions). The client 202 then signs the air bill indicating that the documents have been dispatched to the courier. The courier 206 attaches three copies of the air bill to the box/package of documents and hands one copy back to the client 202. The courier 206 then scans the air bill to indicate that the package has been collected.

Next, the client 202 sends, to the client coordinator, an e-mail 224 containing the air bill number. The air bill number can be a sequential unique identifier that is pre-printed on the air bill. This number allows the documentation to be tracked on the courier's system. The exchange service provider 210 uses this number to track the documentation.

Once the package has been collected, it can be returned to the courier local service center 204 where the delivery details supplied by the client 202 are put into effect. Throughout the procedure, the package is scanned at different points in the courier's network. At the destination country, state, or region, the package is again given to a courier (who may be the same as or different from the courier 206) who delivers the package to the location of a scanner 208. At this location, the documents within the package are scanned using the scanner 208 to create digital documents. The digital documents can then be made available on the asset exchange to users of the exchange, including to the potential purchasers of the asset, swappers, or barterers.

The package preferably retains the same air bill number throughout the entire process. The client coordinator at the exchange service provider 210 can track the delivery of the package using the air bill number. This can be done by making a tracking request 228 to a tracking service 212 provided by the courier 206. The tracking service 212 can optionally be provided through human assistants, an intranet provided by the courier 206, or the Internet (e.g., the World Wide Web). Upon receiving the tracking request 228 generated by the exchange service provider 210, the tracking service 212 sends package status information 230 to the client coordinator at the exchange service provider 210. After the documents have been scanned, they can be returned from the scanning location to the client 202 using the same courier 206 or a different courier.

Documents associated with an asset can be incorporated into a word-searchable database associated with the asset. A participant can use the database to find information about an asset even without having prior knowledge of, e.g., the location of the asset. In particular, a search of the documents can be performed using search software (a/k/a “a search engine”), by entering one or more words (e.g., keywords) into the search engine, whereupon the software reveals documents containing the words used in the search.

Information contained in the documents can be organized according to one or more fields representing various types and/or categories of information. A search can specify one or more fields in which to search for the keywords. Such fields can optionally include: introduction, license information and history, geology and geophysics, reserves, development, production, commercial and legal, financial, exploration potential, and other.

In accordance with a preferred embodiment of the present invention, a “virtual workspace”—e.g., an advantageous electronic environment presented to the user—provides the users with the information they need to make an acquisition or financing decision related to an asset. An on-line data room accessible from within the virtual workspace can provide access to legal, commercial, and/or geo-technical information associated with the oil and gas assets. The format of the information can, for example, range from simple text files to images or video. As discussed in further detail below, the virtual workspace can also deliver relevant third-party content, and can provide access to third-party applications and services for the evaluation of the oil and gas assets. In addition, relevant transactions (such as asset transactions, financial transactions, and information transactions) can be performed from within the virtual workspace, as is also discussed in further detail below.

The virtual workspace can be configured so that access to it and its data room is restricted to a selected group of parties or users. The selected group can, for example, include a restricted set of financial institutions. Such restricted access can facilitate confidential, on-line discussions among the parties or users within the selected group. A party can have access to one or more workspaces containing the information relevant to that particular party. Furthermore, one or more workspaces can be devoted to a specific asset, asset package, or financial package.

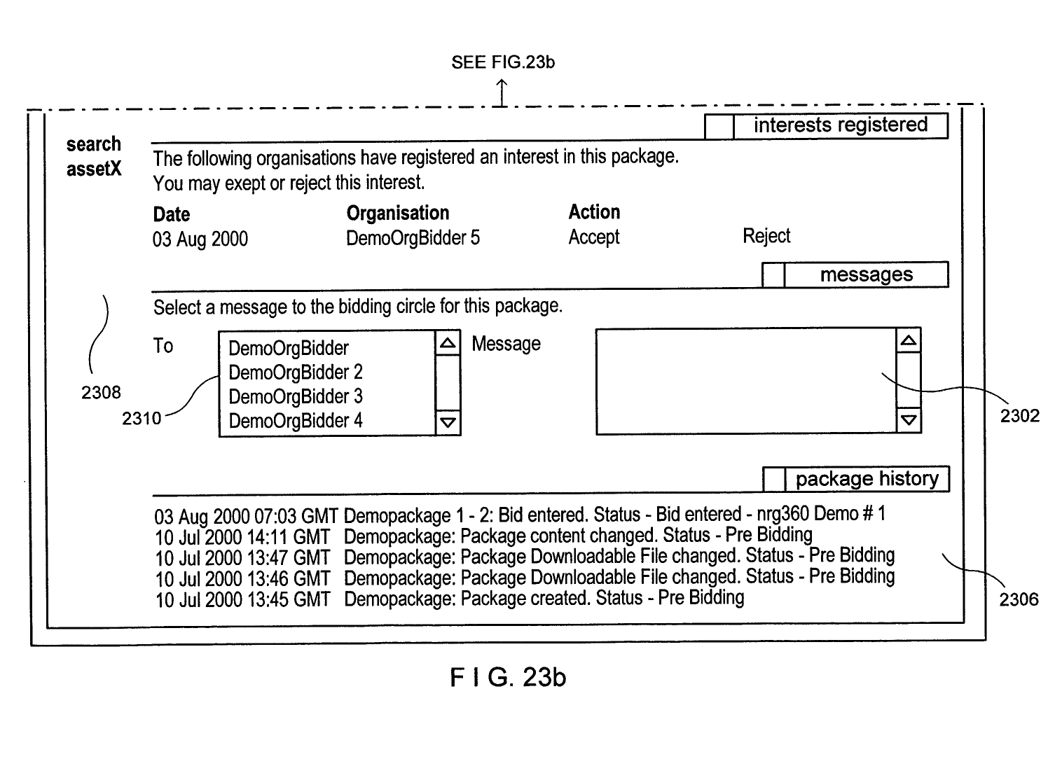

FIG. 24 illustrates an example of a display 2412 for a graphical user interface (“GUI”) for a virtual workspace associated with a particular asset in accordance with the present invention. The display can include information regarding the asset, such as text information 2402, a map 2404 of the geographic region containing the asset, and a narrative 2406 describing features of the asset, and results of analysis of the natural resources (e.g., oil or natural gas) likely to be found within the asset. The display 2412 can also include a link (e.g., a button 2408) to an on-line data room, as well as a link (e.g. a button 2410) to other information.

A virtual workspace in accordance with the present invention can provide a secure repository of information, products, and services suitable for supporting the valuation of assets. Key features available from within the virtual workspace can include digitized and downloadable documents, documents for off-line delivery, industry commentary and analysis, and analytical tools provided by ASP third-party services.

In accordance with the present invention, the exchange service provider 210 can provide an on-line data room creation service. To create a data room, the exchange service provider 210 can collect documents from multiple geographical locations, and convert these documents to digital format in one or more central offices. In addition, the service provider can provide maintenance of the on-line data room. Once created, the data room can, for example, be accessed from within the virtual workspace. Preferably, the creation and maintenance of the data room is performed in a confidential manner.

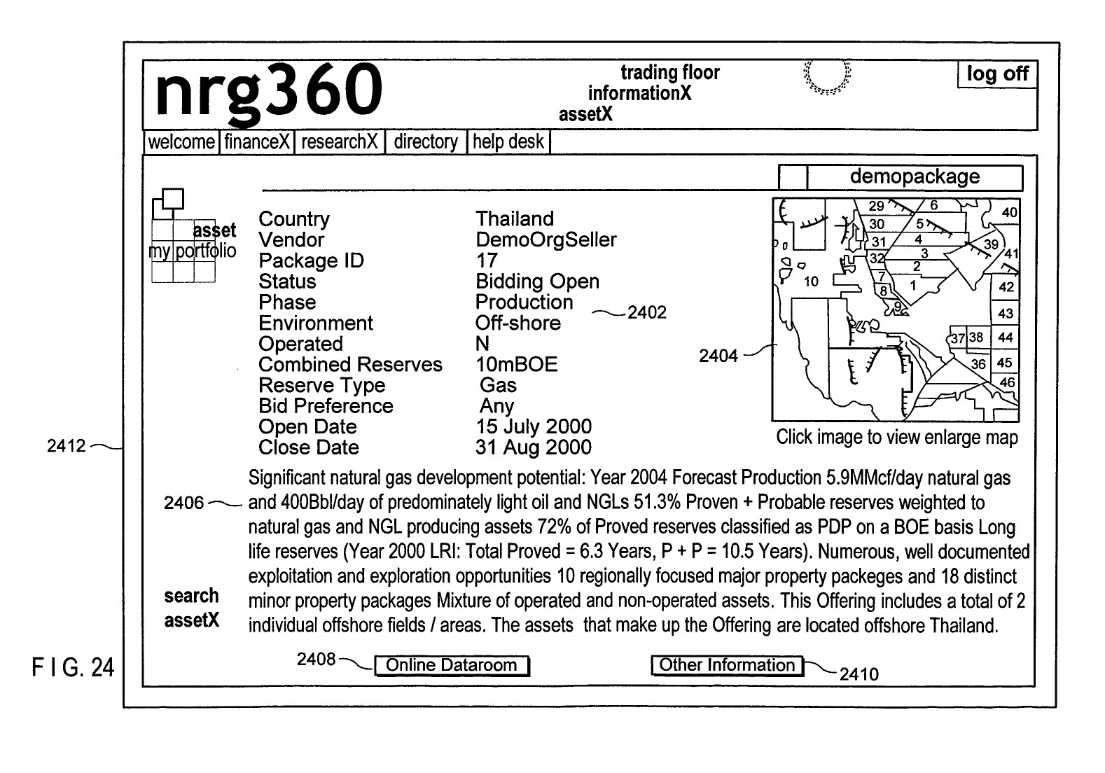

FIG. 25 illustrates an example of a GUI display 2502 for a data room in accordance with the present invention. The data room can, for example, be accessed from a virtual workspace. The data room can provide documents related to an asset, including legal documents, engineering and other technical documents, as well as other information. The data room GUI display 2502 can provide a list 2504 of on-line documents, each of which can be selected by clicking on a brief description of the particular document. The display 2502 can also include a list 2506 of off-line documents which are available by mail or via other off-line methods. In addition, the display 2502 can provide links 2508, 2510, and 2512 to enable a user to “jump” to (i.e., automatically access) the asset exchange, the finance exchange, or the information exchange, respectively.

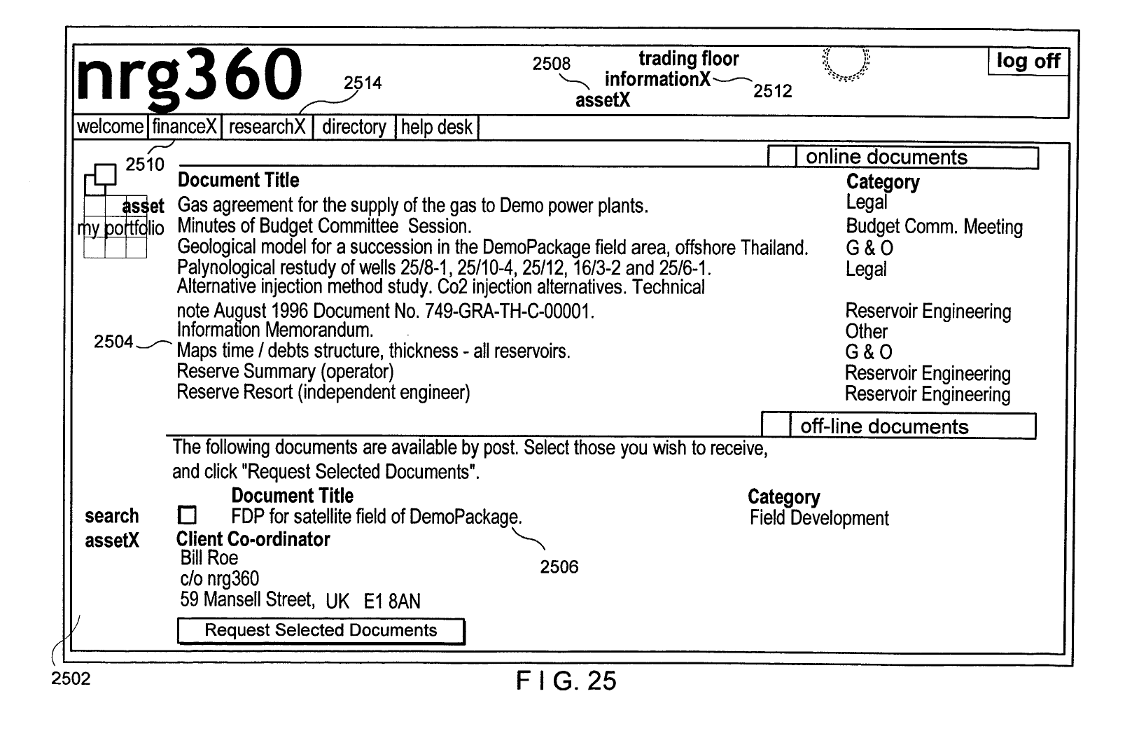

The virtual workspace can also provide a link 2514 to a “research exchange” in order to enable the user to access other information such as research and analysis relevant to the asset, and other third-party information. FIG. 26 illustrates an example of a GUI display 2602 providing access to such information. The display 2602 can provide a list 2604 of documents available for access by the user. The user can access a document by clicking on a brief description 2606 of the document.

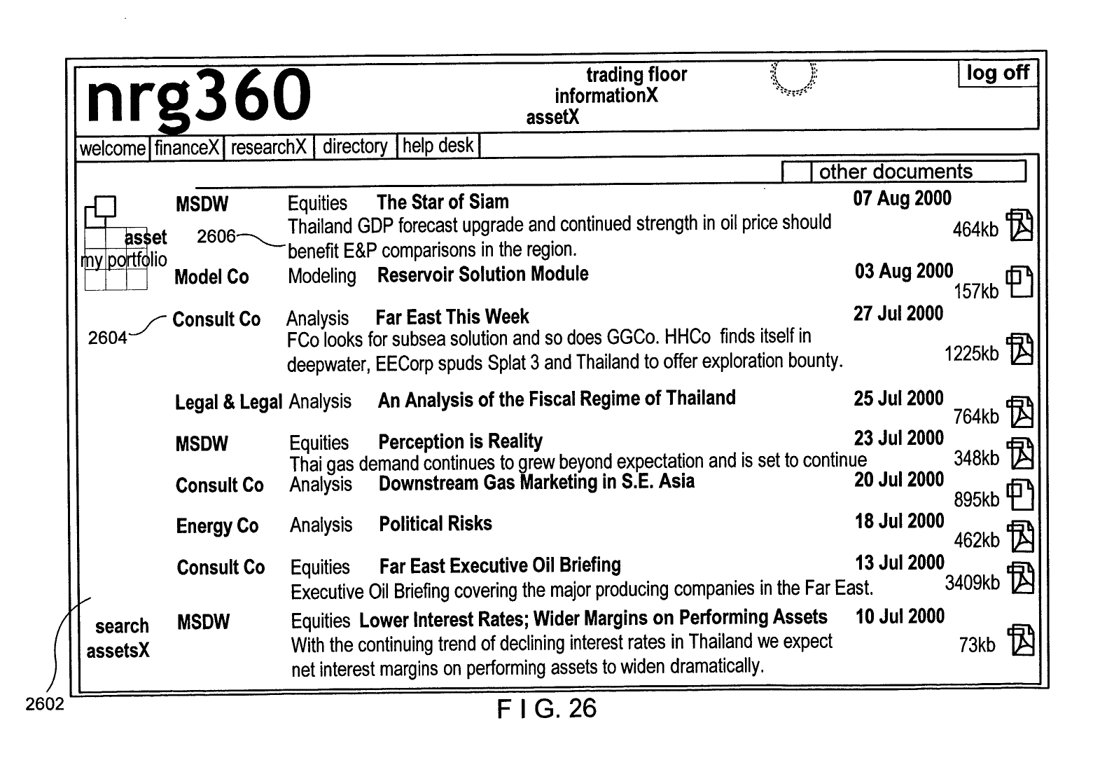

As illustrated in FIG. 27, the virtual workspace can enable the user to display certain information such as, for example, the results from economic analysis, in text format 2702 or graphical format 2704. Within the virtual workspace, the user can apply ASP software to the user's assumptions regarding, e.g., finance and risk, competitive dynamics, and prospectivity.

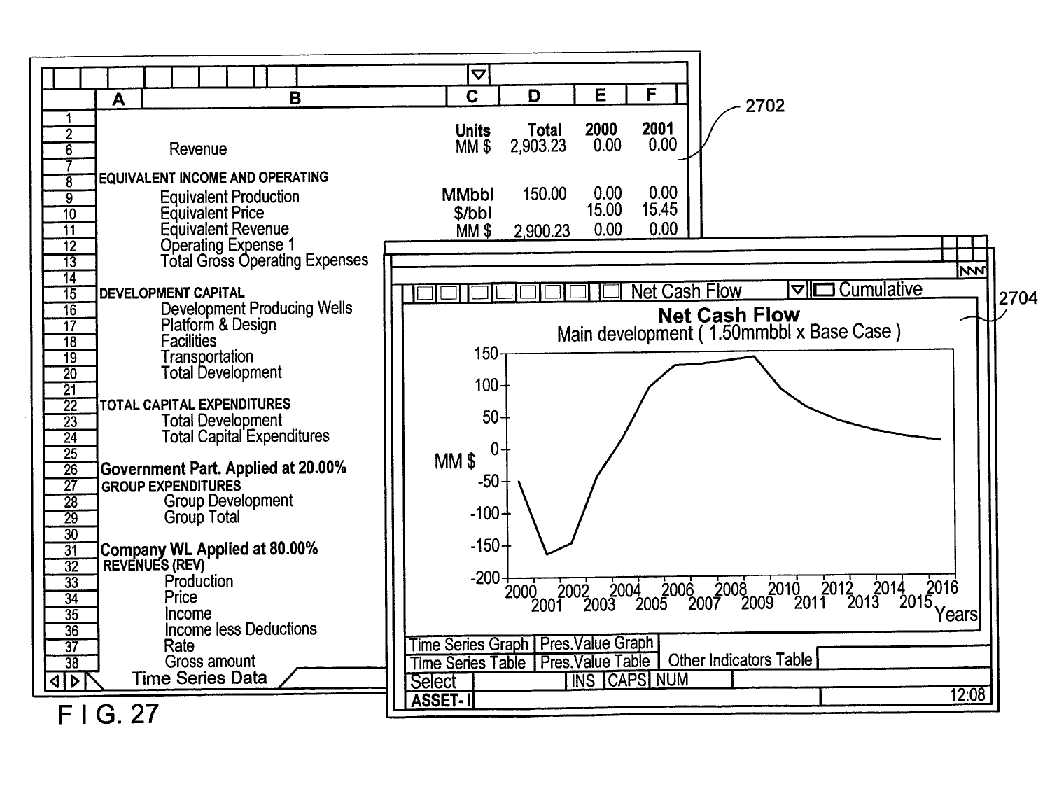

In accordance with the present invention, the system can provide a “landing” page which can effectively serve as a table of contents for the website. The landing page, an example of which is illustrated in FIG. 28, can include links 2802, 2804, 2806, 2808, 2810, 2812, 2814, and 2816, which can direct the user to the asset exchange, a finance exchange, a communications hub, a research facility, an information facility, a trading floor, a directory, and a help desk, respectively. The finance exchange, communications hub, research facility, information facility, trading floor, directory, and help desk are discussed below.

A system in accordance with the present invention can also provide a “finance exchange” which can include a financial marketplace which allows participants to access asset-based financing, acquisition finance (e.g., loans for purchasing assets), project finance, development capital, and risk management services, including commodity and asset risk management services. Proposed financial deals can be listed on the exchange, and participants can optionally use the exchange to execute (i.e., enter into) the deals and transactions. These services need not be limited to financing only for asset transactions which are included on the system (i.e., on the above-described asset exchange).

The finance exchange marketplace can optionally include a platform for companies to interact with one or more capital providers. The finance exchange can service as a secure and efficient link between companies (e.g., users of capital and risk management services) and financial institutions (e.g., providers of capital and risk management services). The companies therefore benefit from a greater choice and an increased access to the available capital. As smaller companies have access to more capital, the liquidity of the asset trading increases. Financial institutions (such as banks) by participating in the system have an opportunity to be involved earlier in the decision making process. This enables them to create better products for their clients, and access a broader customer base. Such services are particularly beneficial for cases in which the decision-making process requires a thorough understanding of the assets, and in which the information requirements are similar to a transaction involving an asset trade. The finance exchange is particularly advantageous for financing smaller deals and transactions such as, for example, those involving less than $500 million. Likely users of this service include small and mid-sized companies who are also likely to be the acquirers of the assets on the asset exchange.

The finance exchange of the present invention can enable users purchasing the assets to gain access to a variety of capital and finance providers. This benefit is facilitated by the provision (on the exchange) of information about the financial organizations that service the energy industry. The financial organizations can provide the users with various financial packages ranging from generic finance offers to asset-specific finance.

An asset financing process of the present invention can be initiated by a lender, a borrower (who is likely to be the purchaser of the asset), or a seller of the asset. For example, the lender can initiate the financing process by offering a generic finance transaction, or by offering financing related to a specific asset. The borrower can also initiate a process by requesting the finance transaction from a lender. Several exemplary financing processes in accordance with the present invention are described in detail below.

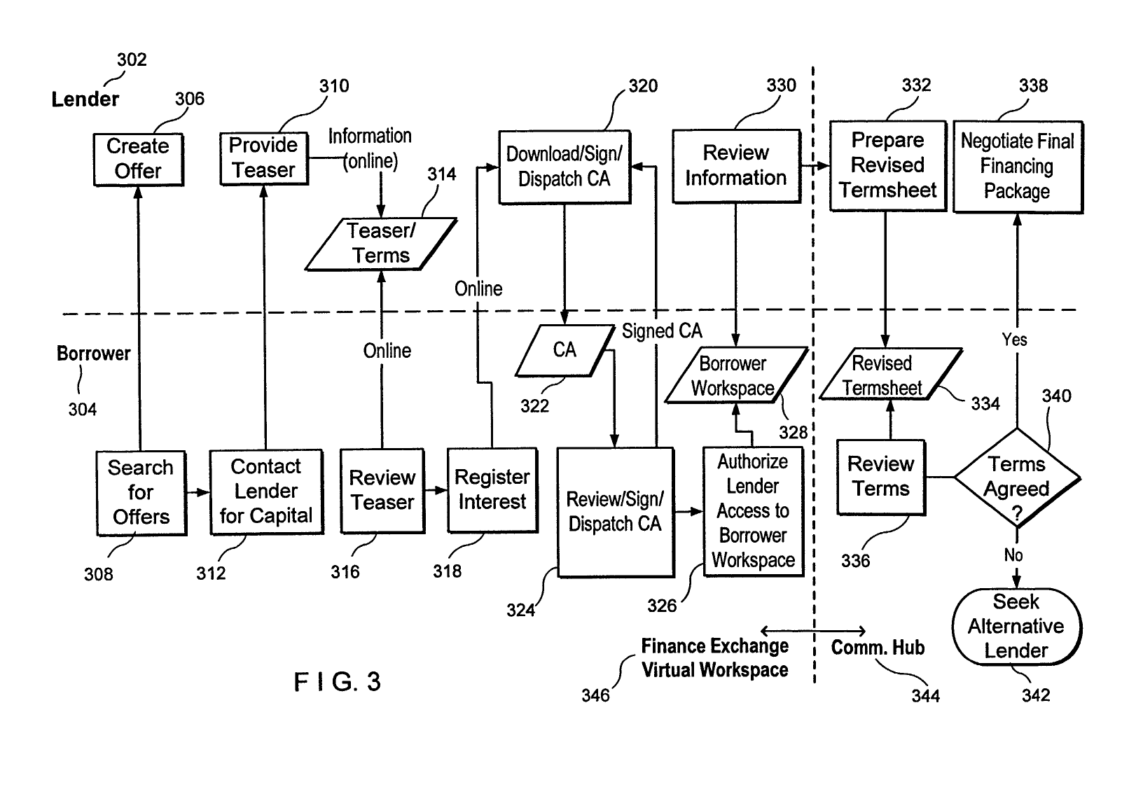

FIG. 3 illustrates an exemplary embodiment of the financing process which can be performed using the finance exchange in accordance with the present invention. In this example, a lender 302 initiates the process by creating (step 306) and advertising (step 310) a generic finance offer for one of a range of finance products. The advertising can, for example, be in the form of a “teaser” (e.g., a brief description) posted on the exchange. The generic finance offer is not specific to any particular asset and may be available from more than one lender.

The finance exchange of the present invention can optionally be configured to enable the lender to create the finance offer on the exchange itself. In such embodiment, the lender first logs on to the finance exchange site, and creates the finance offer by completing a standard template available on the exchange. The template can provide sections for the following exemplary information:

summary of the offer

attachments

definition of target audience (e.g., “include everyone,” “include a specific audience,” or “exclude a specific audience”)

Using the offer information, the system creates a specific Finance Exchange (“FX”) Virtual Workspace 346 for the lender. The information is made available in the FX Virtual Workspace 346, and can include images, a teaser 314, a confidentiality agreement (CA) 322, one or more links to a data room, and other information.

A borrower 304 searches for a finance offer which meets its financial requirements (step 308). The desired financing can be related to, e.g., asset purchase, organization refinancing, or other projects. The borrower 304 can perform searches for lenders using the finance exchange or the trading floor. Optionally, the borrower 304 can contact the lender 302 directly (step 312) in order to obtain one or more teasers or other offer information.

Upon finding of a lender 302, the borrower 304 reviews the lender's teaser information 314 in the FX Virtual Workspace 346 (step 316). If the lender's offer is suitable, the borrower 304 registers an interest in the offer (step 318). The borrower 304 can optionally provide additional comments in its communication with the lender 302.

If desired, the borrower 304 can store the lender information in a digital storage directory designated for this and other purposes. The storage directory can be referred to as, for example, the borrower's “My FX Interests” folder.

In the exemplary embodiment of FIG. 3, the lender 302 agrees to participate in discussions with borrower 304, and accordingly (in steps 320 and 324), both parties sign a CA 322 before the lender 302 allows the borrower 304 to view the details of the offer in the lender's FX Virtual Workspace. The CA 322 can optionally be executed (i.e., entered into) via the communications hub 344.

Based on the foregoing discussions, the borrower 304 may accept or decline the terms and conditions proposed by the lender 302. If the terms and conditions are declined, the “discussions” between the parties are terminated or suspended. Otherwise, if the offer is acceptable, the borrower 304 can accept it by notifying the lender 302 of the acceptance, via the communications hub 344. The borrower 304 can, optionally, add the lender's details to the borrower's “My FX Selections” folder. If the borrower 304 accepts the offer, the borrower 304 grants the lender 302 access to the borrower's workspace 328 (step 326) to allow the lender 302 to assess the suitability of the borrower 304 for the possible finance transaction.

The borrower 304 can create a virtual workspace on the system and can include, in the workspace, information about the borrower's organization and other relevant information that the lender 302 may require. Each of these workspaces can be specific to the lender 302, and the borrower 304 can have more than one virtual workspace.

Next, the lender 302 reviews the financial position of the borrower 304 (e.g., by running a credit check through a financial or credit rating agency) in step 330. If the borrower 304 is suitable, the lender 302 creates a tailored finance offer which may have certain revised terms. The lender 302 prepares a revised term sheet 334 setting forth the revised terms (step 332), and sends the revised term sheet 334 to the borrower 304 via the communications hub 344. The communications hub 344 can, optionally, included a secure extranet or another communications network.

The borrower 304 then reviews the revised terms (step 336), and decides whether or not to accept them (step 340). If the borrower 304 agrees to the terms, a final financial package can then be negotiated through the communications hub 344 (step 338).

If, in step 340, the borrower 304 chooses not to accept the proposed terms, then the borrower 304 can optionally seek financing from an alternative lender (step 342).

The finance exchange can optionally be configured to require the lender 302 or the borrower 304 to provide information regarding the outcome of their discussions or negotiations so that the exchange service provider 210 can record and store such information.

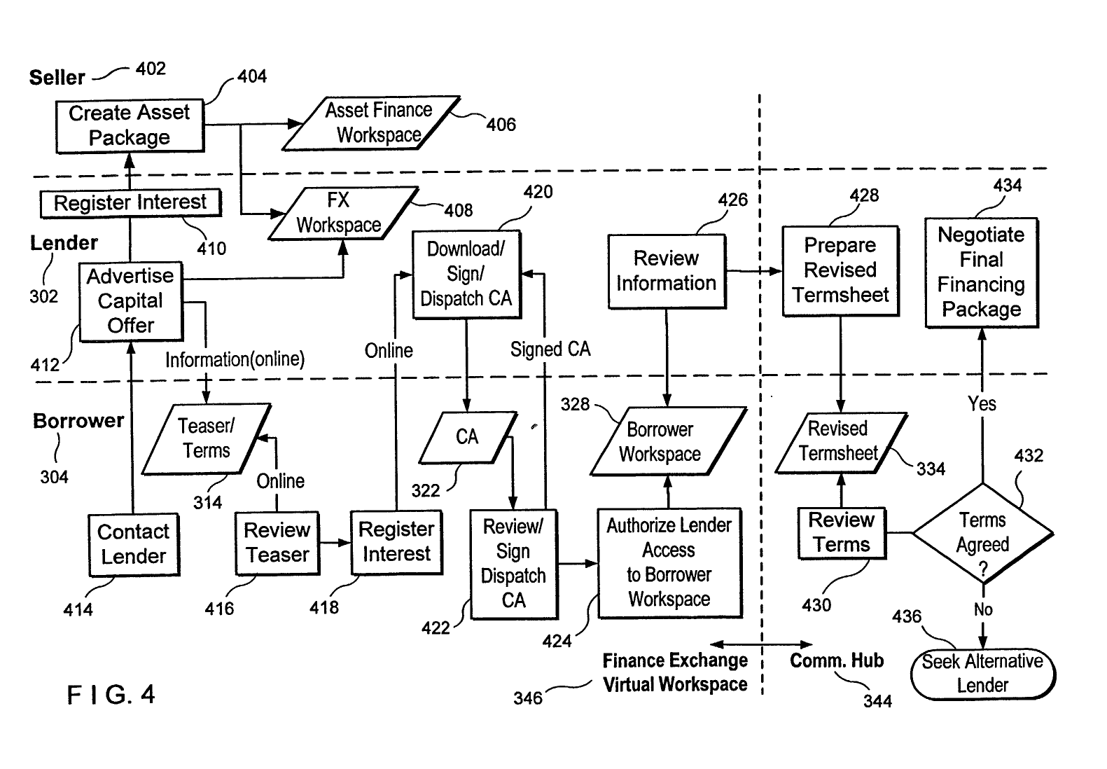

FIG. 4 illustrates another example of a financing process which can be performed on a finance exchange in accordance with the present invention. This exemplary process involves an offer of asset-specific financing by a lender. The asset package can, but need not be, listed on the asset exchange, and the financial offer can encompass future assets. The process of FIG. 4 begins with a seller 402 creating an asset package for sale (step 404). The information provided in the asset package is placed in an Asset Finance Virtual Workspace 406 which can optionally be separate from the Asset Exchange Virtual Workspace. The lender 302 reviews the asset information, and registers an interest with the seller 402 with regard to providing a finance package for the asset (step 410). This is done in a FX Virtual Workspace 408 where the seller 402 can view the lender's information. Further information about the lender 302 can be discussed through the communications hub 344. The finance package can optionally be specifically tailored for the particular asset. The seller 402 then reviews the lender's credentials, and if these credentials are suitable, authorizes the lender to proceed with the advertising of the finance offer. The lender 302 advertises the FX finance package offer on the FX Finance Exchange (step 412) by providing, e.g., a teaser 314.

The borrower 304 can, optionally, contact the lender 302 directly to obtain certain information (step 414), and/or can search or browse for offers on the exchange. The borrower 304 who sees the lender's offer on the exchange can review the teaser information 314 in the lender's FX Virtual Workspace 408 (step 416). If the borrower 304 is interested in the offer, this borrower 304 can register the interest therefor (step 418).

The lender 302 then agrees to participate in discussions with the borrower 304, and thus, both parties sign a CA 322 (steps 420 and 422). Based on discussions with the lender 302, the borrower 304 can accept or decline the lender's terms. If the terms are declined, then the “discussions” between the parties are terminated or suspended. Otherwise, if the terms are accepted, the borrower 304 authorizes the lender 302 to access the borrower's virtual workspace 328 (step 424). The lender then reviews the borrower's financial position and suitability (e.g., performs a credit check) in step 426. If the borrower 304 is acceptable, the lender 302 creates a suitable tailored finance offer, and prepares a revised term sheet 334 (step 428). The lender 302 sends the term sheet 334 to the borrower 304 via the communications hub 344.

The borrower 304 next reviews the proposed terms (step 430). If the borrower 304 is satisfied with the terms (step 432), the parties can negotiate a final agreement via the communications hub 344 (step 434). If, in step 432, the borrower 304 is not satisfied with the proposed terms, the borrower 304 can optionally seek financing with an alternative lender (step 436).

In addition, a seller of an asset can use the finance exchange to assess the financial standing and/or credit-worthiness of an actual or potential bidder or purchaser. The seller can perform such an assessment by accessing a financial and/or credit report produced by a financial and/or credit rating agency. The report can be requested and obtained on-line.

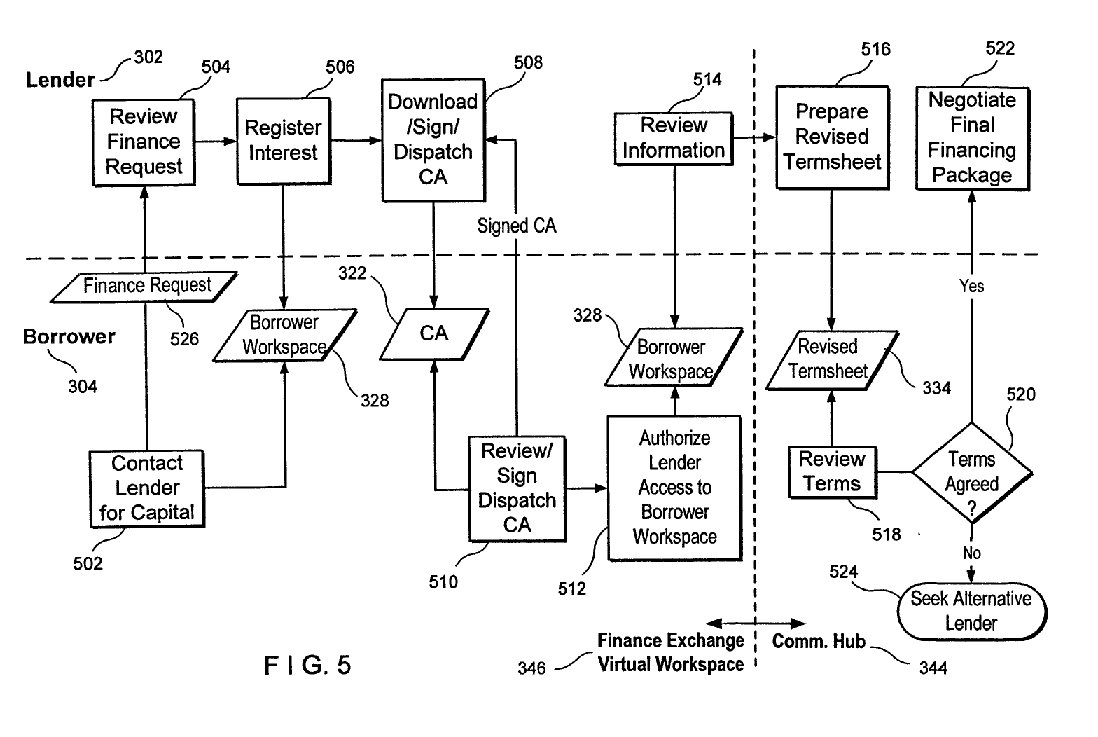

FIG. 5 illustrates another example of a financing process which can be performed on the finance exchange in accordance with the present invention. In the example of FIG. 5, the process is initiated by a borrower 304 seeking financing to support a current or proposed asset purchase. The borrower 304 places a request for financing 526 on the finance exchange (step 502). The request 526 can include a stipulation about the borrower's choice of lenders. At the same time, the borrower 304 creates a FX Virtual Workspace 328 which contains information about the borrower 304. The finance offer requested by the borrower 304 can optionally be non-specific to any asset, and may be available from more than one lender.

These lenders can search the finance exchange for borrower finance requests. For the particular borrower 304, only lenders approved by the borrower 304 are given access to that borrower's finance request. An authorized lender 302 can review the available finance requests (step 504), and if interested in a particular request, may register its interest in offering finance (step 506). The lender 302 may agree to participate in discussions with the borrower 304, and thus, both parties sign the CA 322 (steps 508 and 510).

Next, the borrower 304 grants the lender 302 access to the borrower's workspace 328 (step 512) to allow the lender 302 to assess the borrower's suitability for the financing. The lender 302 reviews the borrower's financial position (e.g., by running a credit check) in step 514. If the borrower 304 is acceptable to the lender 302, the lender creates a suitably tailored finance offer. The lender 302 prepares a revised term sheet 334 containing the terms of the offer (step 516), and sends the term sheet 334 to the borrower 304 via the communications hub 344. Optionally, the lender 302 can provide a range of tailored finance offers. The borrower 304 reviews the proposed terms (step 518). If the borrower 304 accepts the terms (step 520), the parties can negotiate a final package via the communications hub 344 (step 522). If, in step 520, the borrower 304 chooses not to accept the proposed terms, the borrower 304 can, optionally, seek financing from an alternative lender (step 524).

The financing service need not be limited to providing capital for asset transactions conducted on the system of the present invention. Companies and capital providers can also use the infrastructure of the present invention to raise capital for other acquisition and development projects.

Potential benefits of the services offered by the above-described system and process include the following:

Companies benefit from greater choice and increased access to the capital;

Smaller companies gain access to more capital, resulting in an increase in the liquidity of the asset trading;

Financial institutions can be involved earlier in the decision making process, thus enabling them to create better products for their clients; and

Financial institutions are provided with access to a broader customer base.

In addition, the system can provide risk management services, which can include execution of transactions designed to insure or hedge against risks associated with the value and/or productivity of one or more assets. For example, an oil company can use the asset and finance exchanges to purchase a put option from a financial institution. Such a put option can effectively give the oil company a right to sell to the financial institution a minimum amount of oil for a minimum price. For example, an oil company might purchase a put option for 10,000 bbls/day at $18/bbl for a specified number of days. If the market price were to drop below $18/bbl, the financial institution could satisfy its obligation under the contract by purchasing the oil, or by paying the difference between the option price and the market price.

A system in accordance with the present invention can also provide decision support services which can include web-based delivery of content and applications in a context relevant to the user. Subscribers (i.e., users) can access a comprehensive set of content and applications using a familiar interface. The system can optionally employ a single billing system to enable the users to monitor usage and costs. Vendors (e.g., providers of decision support services) can also benefit from the distribution platform and billing system of the present invention. The present invention can also enable vendors to utilize web-based delivery systems and pay-per-use pricing models.

The support services and tools provided in accordance with the present invention can include, but are not limited to, industry and market data, (e.g., commodity and share prices), financial modeling tools and other analytical tools, geo-technical applications, specialized research and content, consulting services (e.g., tax, legal, and technical services), news (e.g., energy-related news), data visualization services, and credit checking.

In addition, a system in accordance with the present invention can provide further support services such as, for example:

New third party services (e.g. other content and applications) based on customer needs;

Services such as customer profiling and transaction profiling; and

Use of the collaboration network by companies to allow collaboration on development projects.

The system of the present invention can also serve as a distribution platform for the provision of third party content, applications, and decision support services. Such third party services and applications preferably compliment the primary services described herein (e.g., the asset exchange, the finance exchange, the knowledge exchange discussed below, and the other support services) described below, and can include, for example:

Industry data;

Financial modeling and other analytical tools;

Geo-technical applications;

Specialized research and content;

Consultancy services (including tax-related, legal and technical services); and

News (e.g., energy-related news).

One of the objects of these services is to assist the users in making informed decisions about the transactions by delivering the services in the appropriate context and at the proper time. The users are preferably given access to relevant content, applications and services through a unified platform and interface described above. The service providers can target a broad customer base, market their services in the appropriate context, and benefit from an integrated customer billing and management system.

In a particularly advantageous embodiment of the present invention, a “knowledge exchange” marketplace (which can also be called an “information exchange”) provides trading and monetizing of information, including asset-related technical information. The knowledge exchange marketplace can optionally include a knowledge management platform for the upstream oil and gas business, and can also include the ability to link with third-party data warehousing and hosting service providers.

As indicated above, a system in accordance with the present invention can provide on-line access to a cross-section of third-party research and information. The research and information can optionally cover topics such as equity securities, high yield bonds, fixed income bonds, currency exchange, and commodities. For example, such system can provide current and historical prices of stocks, bonds, currency, and commodities. In addition to material provided by a party primarily responsible for the site (e.g., by an exchange service provider), the system can give the user access to other content providers. Examples of the content providers include financial institutions, consulting firms (e.g., business and technical consulting firms), bond and security rating firms, news services, and law firms. The system also provides a “trading floor,” which can comprise a user-customized screen aggregating information from other exchanges and services. Additional features can include customization of collaborative tools and frequently updated research, commentary, and analysis.

In accordance with another aspect of the present invention, a user can express interest in an asset listed on the asset exchange—e.g., by clicking on a hyperlink associated with the asset—and the system can then automatically present, to the user, information and resources having a heightened relevance to the particular asset in which the user has expressed interest. For example, if the user finds an asset listed on the asset exchange, and uses the interface of the system to select the asset, the system can automatically select especially relevant information and resources (e.g., information about the characteristics of that particular asset, research results of particular relevance to the asset, information on obtaining financing suitable for purchasing the asset, and analytical software suitable for analyzing data related to the asset). The analytical software can be provided by a third party and may include economic analysis software or data visualization software.

The information exchange can be configured to enable a user to execute a purchase of information from an information provider such as, for example, the exchange service provider or a third party. For example, the information provider can offer the information for sale by listing it on the information exchange. A user desiring to purchase the information can execute a purchase of the information by accepting the offer. Services for analysis and visualization of data can be similarly offered and purchased. In addition, a user seeking information can post, on the information exchange, an offer to purchase information or software services. An information provider or service provider can execute a sale of the information or services by accepting the posted offer. The transactions such as those described above can include cash purchases and/or barter transactions.

In addition, the system can provide a directory of services, which can include a searchable list of energy-related services for the oil industry. In accordance with the present invention, standards can be developed with respect to:

Legal documentation;

Information disclosure; and

Extensible Markup Language (XML) tags (i.e. which can be adopted as a standard for identifying the different types of documents).

The system can also employ subject-specific or industry-specific standards.

An exemplary embodiment of the system in accordance with the present invention can also provide a grouping of services to facilitate communication between members both on-line and off-line. Network services can include file sharing, secure e-mail, on-line messaging, on-line conferencing, and other tools. The e-mail and other services can be customized according to the user's preferences.

The system of the present invention can provide advanced network services including broad bandwidth, Asymmetric Digital Subscriber Line (“ADSL”) service, Frame Relay, “visualization” (i.e., graphical and pictorial display of data), and secure Virtual Private Network (“VPN”).

ADSL is a type of Digital Subscriber Line (“DSL”) technology. DSL is a technology commonly used to provide a communications link to home or office computers. ADSL provides high “downstream” bit transmission rates (i.e., rates of transmission into the home or office), and lower “upstream” rates (i.e., rates of transmission out of the home or office).

Frame relay is a high-speed packet switching protocol commonly used in wide area networks (“WANs”).

A VPN is generally defined as a private network of computers that is at least partially inter-connected using public communications systems such as, for example, public telephone lines or the Internet. The VPN can use an Internet Protocol (“IP”). In order to ensure privacy, the VPN can use techniques such as encryption and secure protocols.

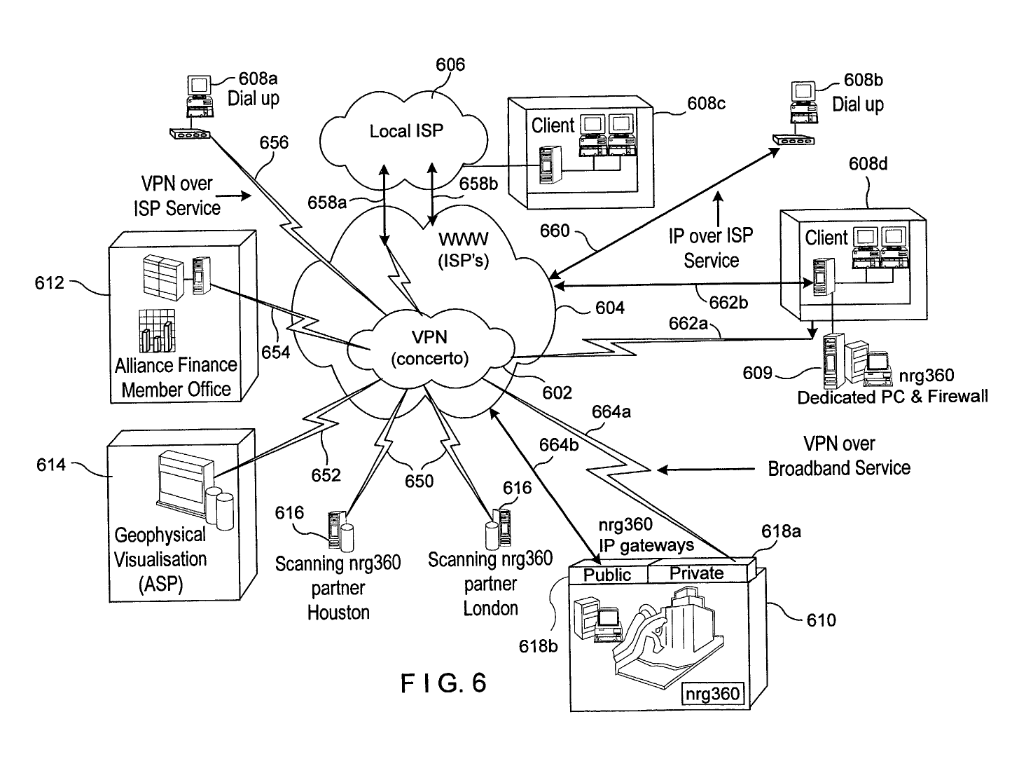

FIG. 6 illustrates an example of a VPN 602 to which various parties are connected in accordance with the present invention. An exchange service provider 610 can be connected to the VPN 602 using a private gateway 618a and a public gateway 618b . The public gateway 618b can be connected to the VPN 602 through a connection 664b to the World Wide Web 604. The private gateway 618a can be connected to the VPN 602 through a direct connection 664a. The direct connection 664a can be implemented using a broadband service. Scanning service providers 616, a data visualization service provider 614, and a financial institution 612 can be connected to the VPN 602 through connections 650, 652, and 654, respectively.

The users of the exchange services can connect to the VPN 602 by various methods and using different communication arrangements. For example, user 608a is connected to the VPN 602 through a connection 656 provided by an internet service provider (“ISP”). A user 608b is connected through the World Wide Web 604 using an IP connection 660 provided by an ISP. The users 608a and 608b can access their respective ISPs using dial-up connections. A user 608c is connected to a local ISP 606, which can connect to the VPN 602 using either a direct connection 658a or a World Wide Web connection 658b. A user 608d can connect to the VPN 602 through the World Wide Web 604 using a connection 662b to the World Wide Web 604 or via a dedicated personal computer (PC) 609 that can be configured to have a firewall for added security. The dedicated PC 609 can connect to the VPN 602 through a direct connection 662a.

The system and process of the present invention is well suited for handling asset transactions worth less than $200 million. An increased amount of corporate and strategic restructuring within the oil and gas business has led to a sustained increase in the number of transactions near the higher end of the aforementioned market range. This trend is likely to continue in the foreseeable future as companies continue to re-align their portfolios. It is anticipated that the major companies and large independent companies will account for an ever-increasing proportion of the supply of assets, while the smaller companies will be the most likely buyers of these assets (provided that they have continued access to the capital).

The system, process, and service implemented according to the present invention can provide advantages such as liquidity, critical mass, and relationships with service providers. In particular, benefits can include:

Efficiency gains over traditional asset acquisition and disposal;

Ability to monetize stranded and illiquid assets with ease;

Access to related information and services which enhance the quality of decision making; and

Enhanced knowledge and information management.

Users having access to a suite of integrated upstream exchanges within one website. A complete trading environment can include comprehensive information sharing, access to capital, capital and risk management, and transaction management;

Extensive alliances and partnering with blue chip service providers to facilitate on and off-line fulfillment;

Unbiased and neutral trading environment;

Fast, flexible development environment enabling rapid change implementation;

Ability to leverage an established, trusted franchise to enhance user trust of the system;

Easy access to research, content, financial products, and Internet offerings;

The system and method of the present invention can also provide on-line services to the oil and gas industries, among others.

In accordance with the present invention, a robust business platform can be facilitated to support the network. In particular, the exemplary system can provide a secure infrastructure that allows oil and gas companies to exchange sensitive information. A system in accordance with the present invention can be configured to provide a complete on-line transaction execution and management service. An advantageous feature of the present invention is the ability to provide related financial services in concert with other transaction services. Support from founding partners can help to ensure long-term liquidity. The features described herein can be delivered on-line as part of a comprehensive suite of tools and services, which can be used to facilitate trading of oil and gas assets.

In accordance with another embodiment of the present invention, any or all of the above services described above, or as shall be described below, can be provided on-line through an Internet “web site.” The web site is preferably configured to be secure and robust.

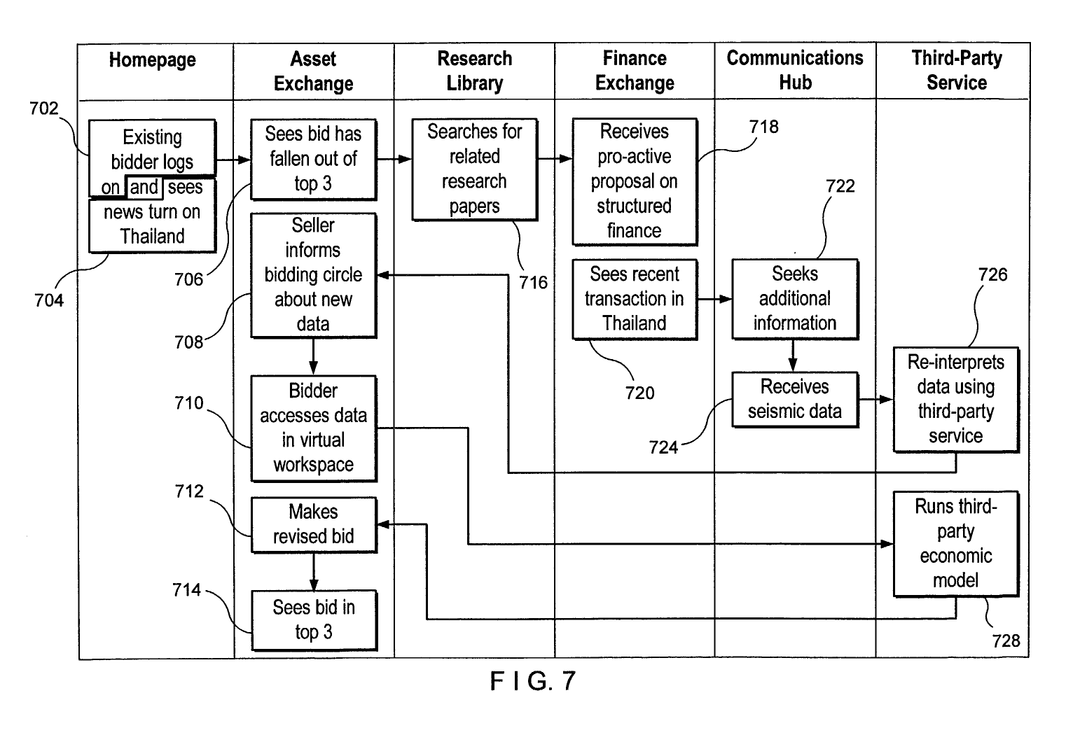

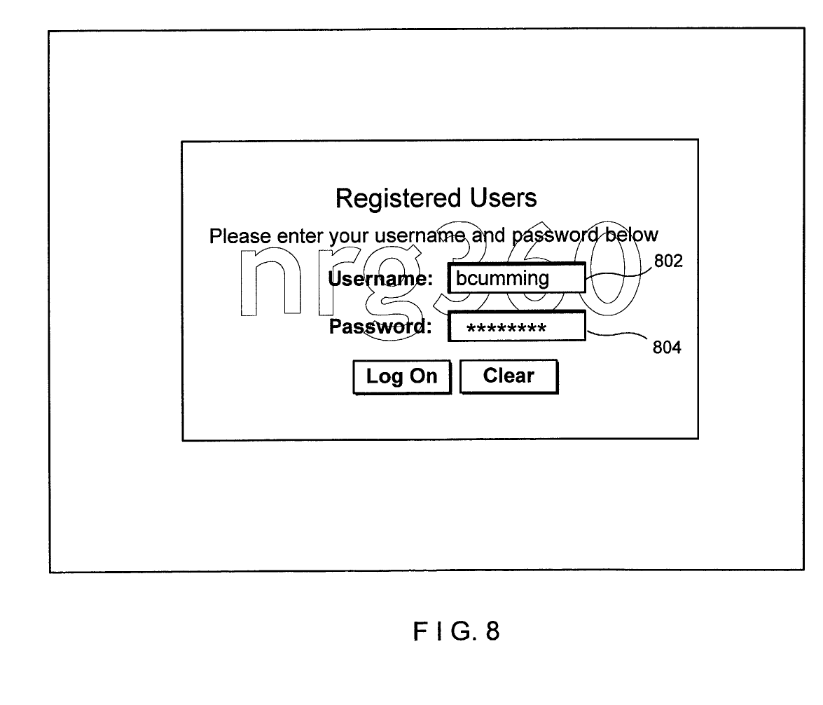

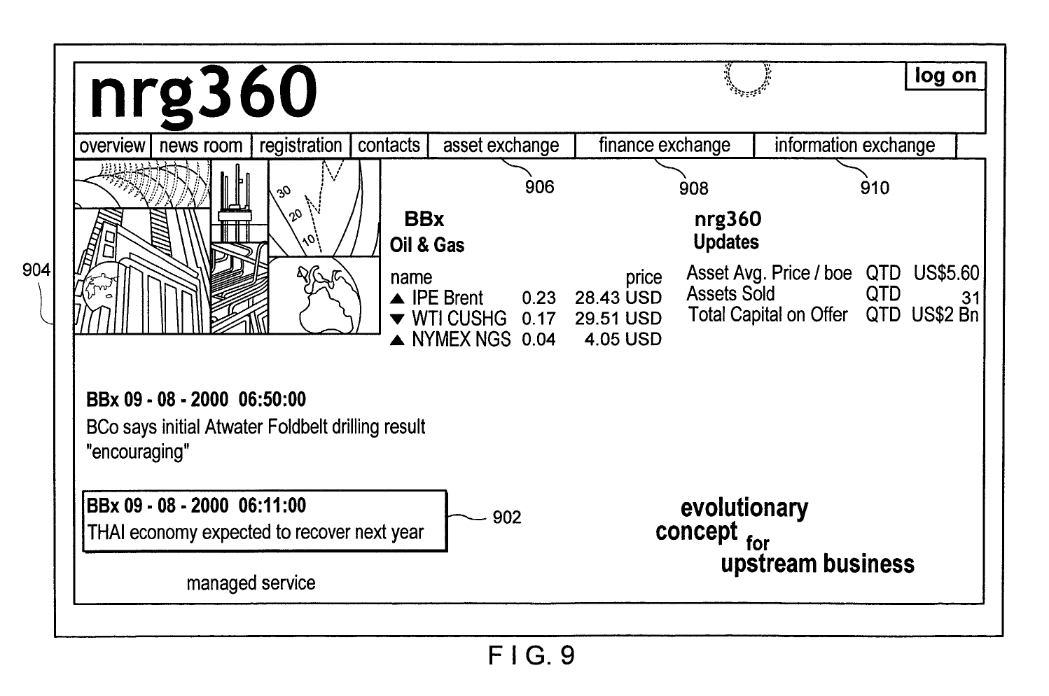

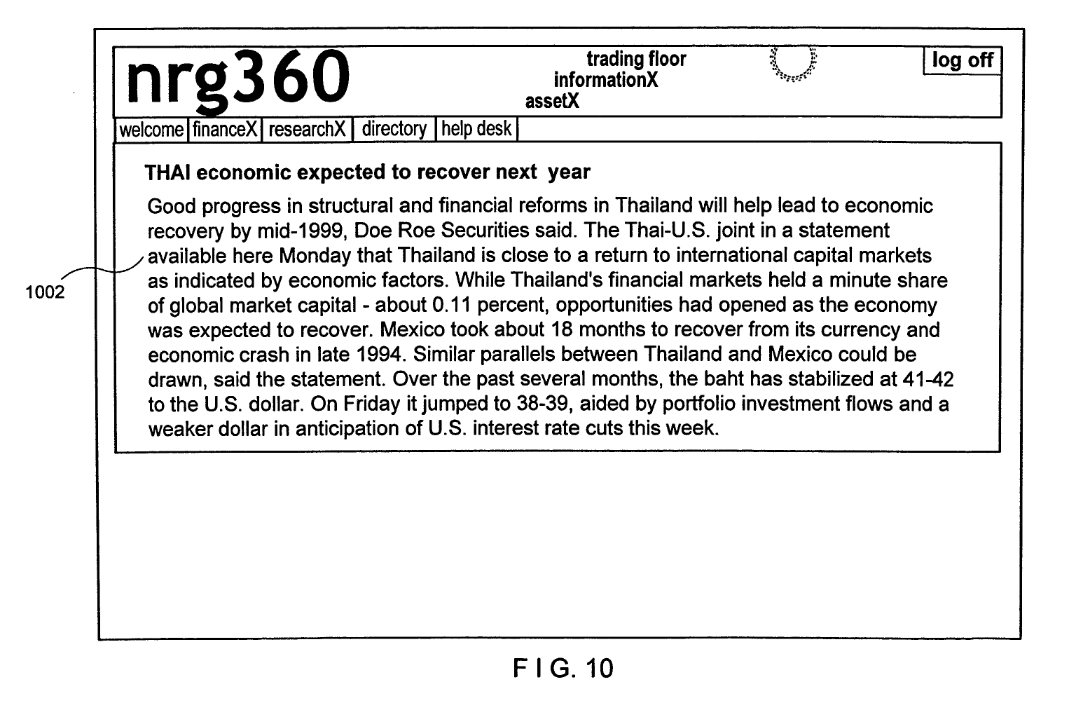

FIG. 7 illustrates an exemplary procedure for utilizing a comprehensive suite of services in accordance with the present invention. This procedure can, optionally, be performed using a web site. The scenario of FIG. 7 involves a user who has already made at least one bid to purchase an asset. For example, the bidder first logs onto the system (step 702). FIG. 8 illustrates an exemplary log-on display of a graphical user interface (“GUI”) in which the user can enter a user name 802 and a password 804. After logging on, a home page 904 (illustrated in FIG. 9) is presented to the user. The home page can provide links 906, 908, and 910 which can enable the user to “jump” to (i.e., automatically access) the asset exchange, the finance exchange, or the information exchange, respectively. In addition, the home page can provide links to relevant news stories. In this case, the user is provided with a brief description 902 of a news item which is relevant to the purchase of the asset (step 704 of FIG. 7). By clicking on the brief description 902, the user can access the entire news item 1002 (illustrated FIG. 10).

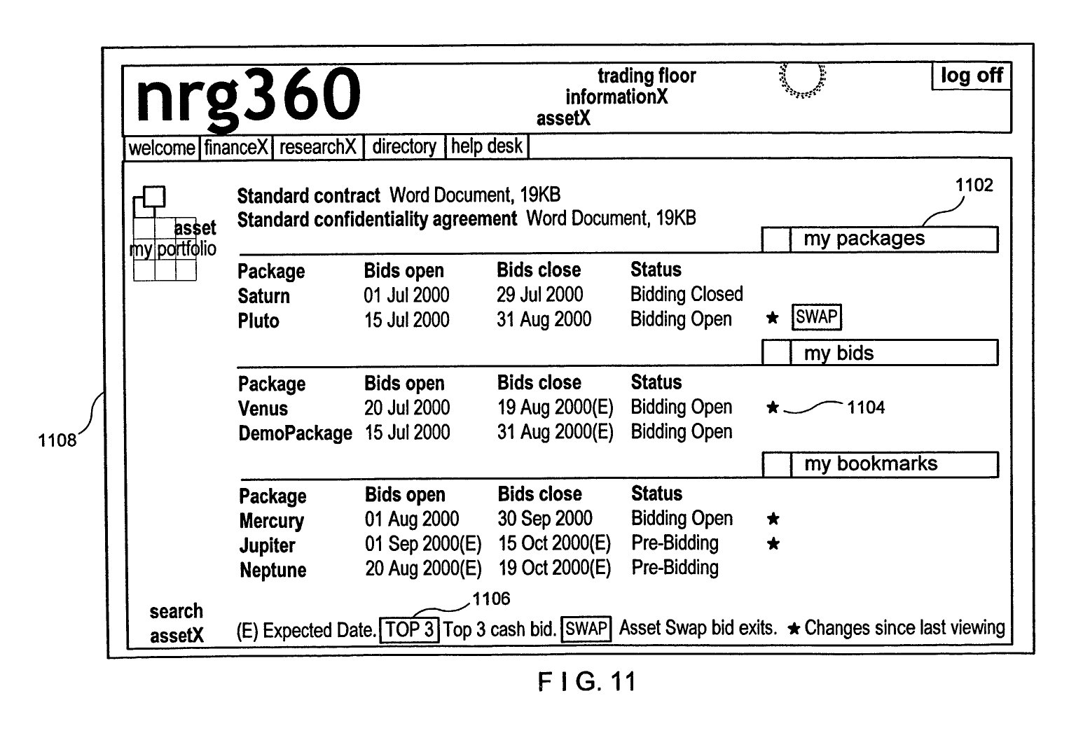

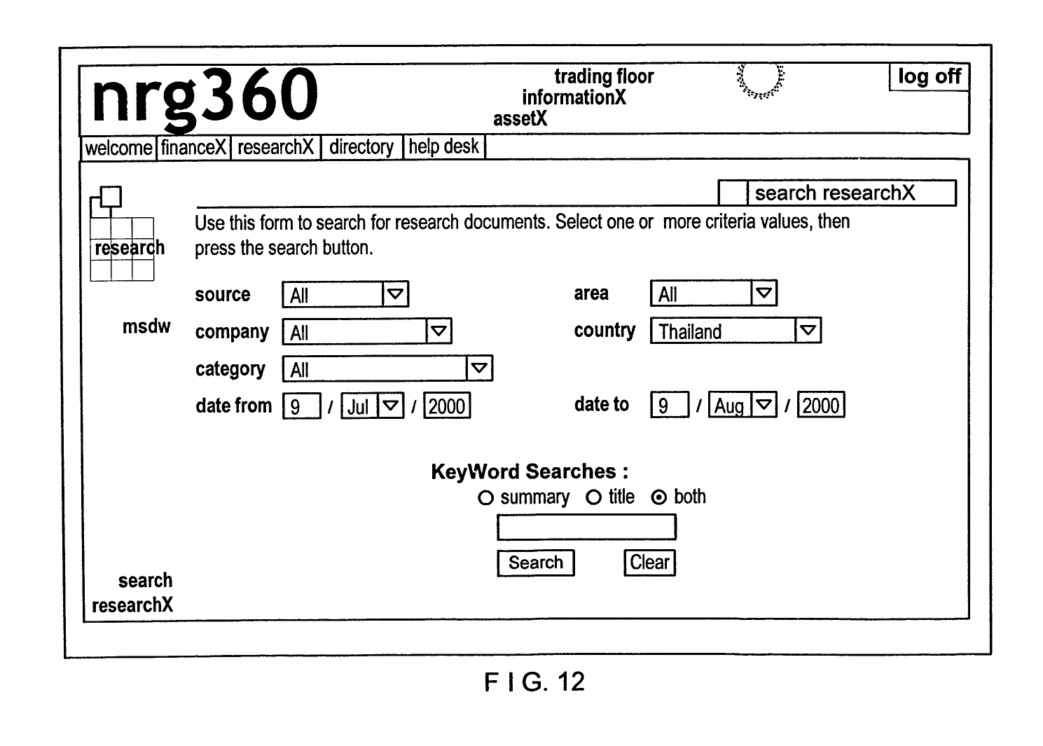

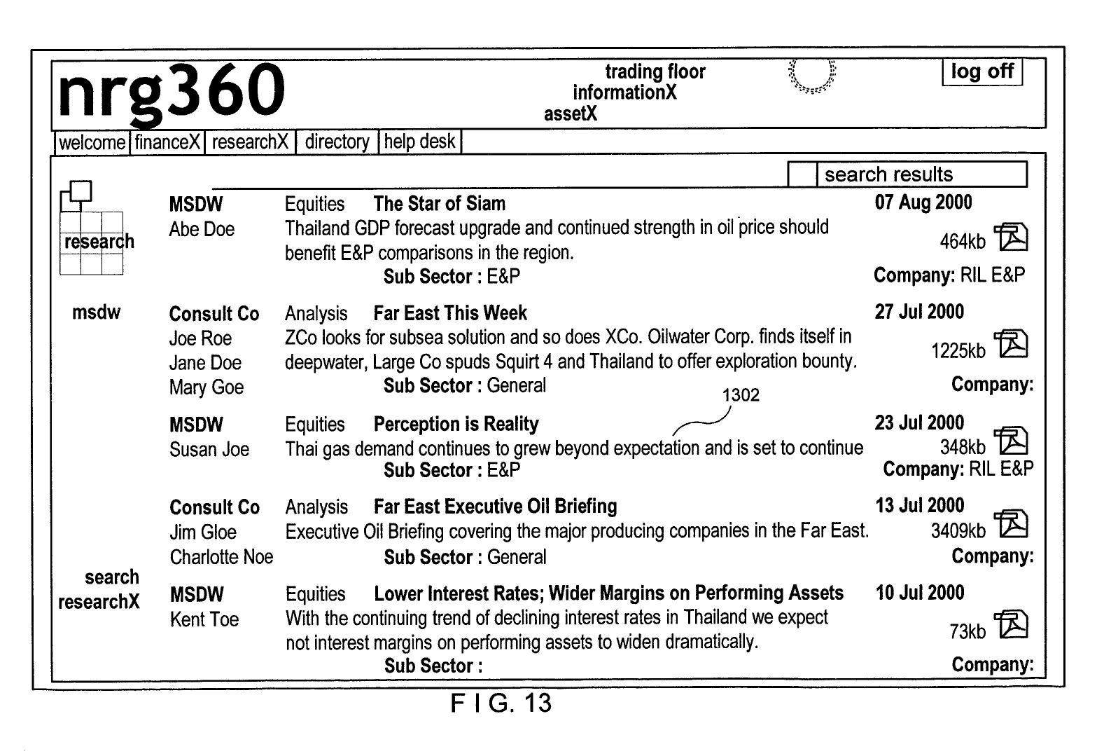

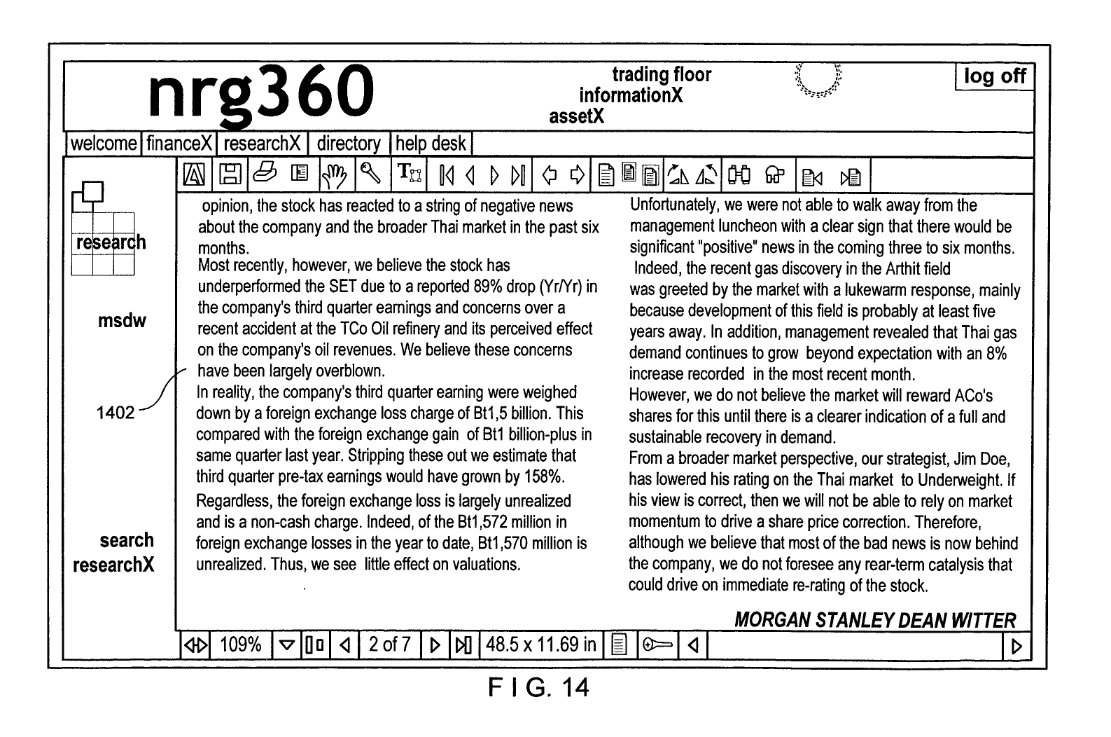

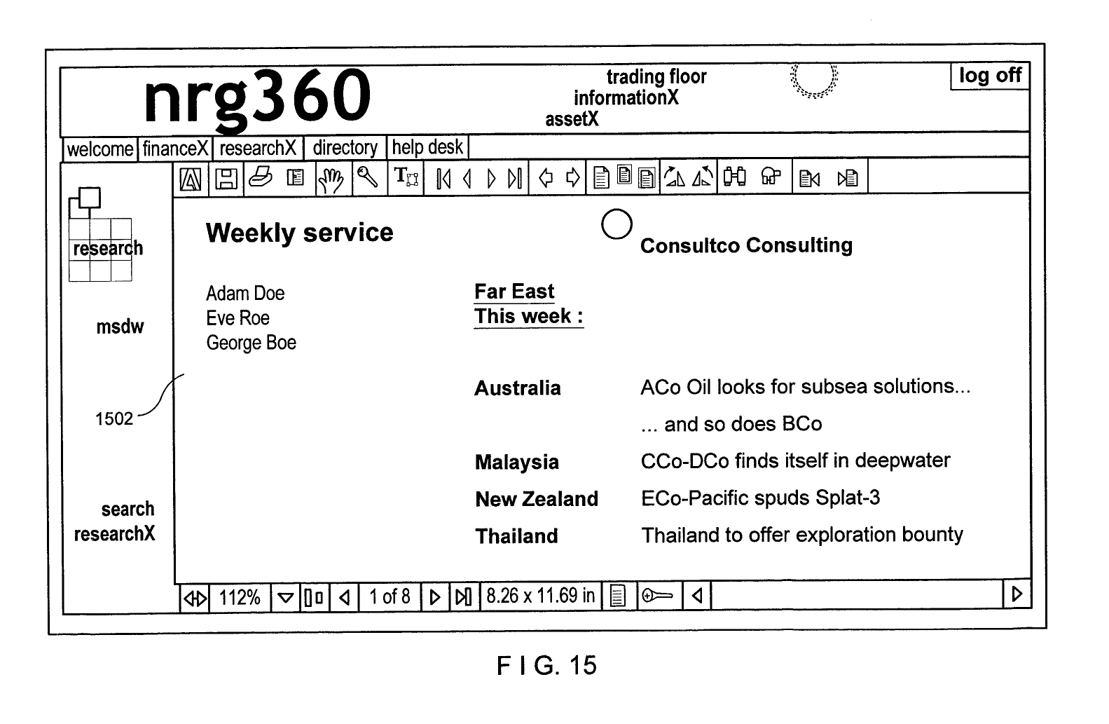

The user can also access the asset exchange to check the status of one or more bids he or she has made. FIG. 11 illustrates exemplary display of a GUI for the asset exchange. The display screen of FIG. 11 includes a column 1102 for indicating the status of various bids. In this case, an indicator symbol 1104 notifies the user that the status of one of his or her bids has changed. Furthermore, the absence of a “top three” indicator 1106 in the bid status column 1102 notifies the user that the bid in question is no longer among the top three (step 706 of FIG. 7). The bidder therefore may decide to search for related research papers (step 716) by using a research library provided on the system. The research library can include a searchable database which can provide tailored information and analysis on subjects relevant to the decision-making process of oil industry professionals. The system can provide digital search software (a/k/a “a search engine”) to facilitate user searches. The library can include general macro-economic analyses, equity research, and industry analysis. The exchange service provider 210 can periodically review the usage of the research library to insure that relevant content is presented to the users. An exemplary GUI for the research library is illustrated in FIG. 12. Using the interface illustrated in FIG. 12, the user is able to search for items relevant to the asset transaction in which he or she is participating. Exemplary search results are illustrated in FIG. 13. In this example, the user finds a brief description 1302 of a research report relevant to the transaction. By clicking on the brief description 1302, the user can access the entire report 1402 (an example of which is illustrated in FIG. 14). The research results can also include a regional activity update 1502, as illustrated in FIG. 15.

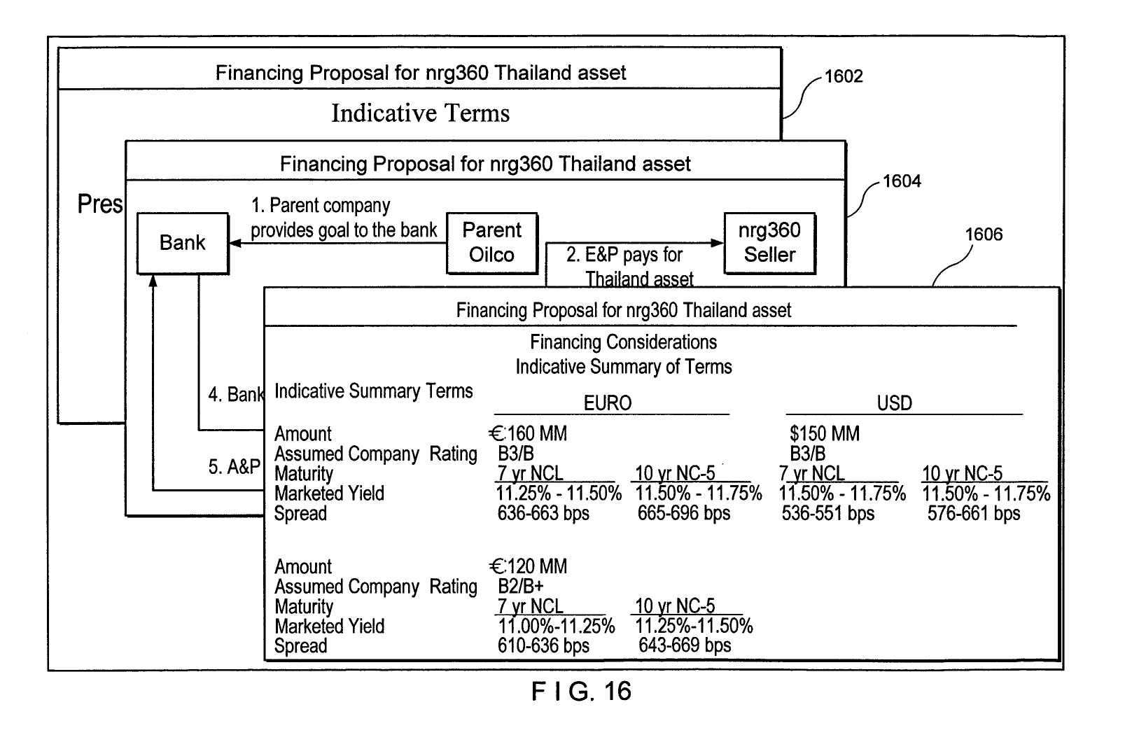

In addition, the user can access the finance exchange. As discussed above, financial institutions can develop tailored finance packages and offer them on the finance exchange. In this case, the user receives such a proposal in step 718 of FIG. 7. The financial institution has observed the activity taking place on the asset exchange, proactively developed a finance package, and marketed the package directly to the target audience i.e., to the user bidding on the asset. FIG. 16 illustrates an exemplary computer display of the tailored finance proposal. The proposal can include indicative terms 1602, a flowchart 1604 illustrating the proposal, and an indicative summary of terms 1606.

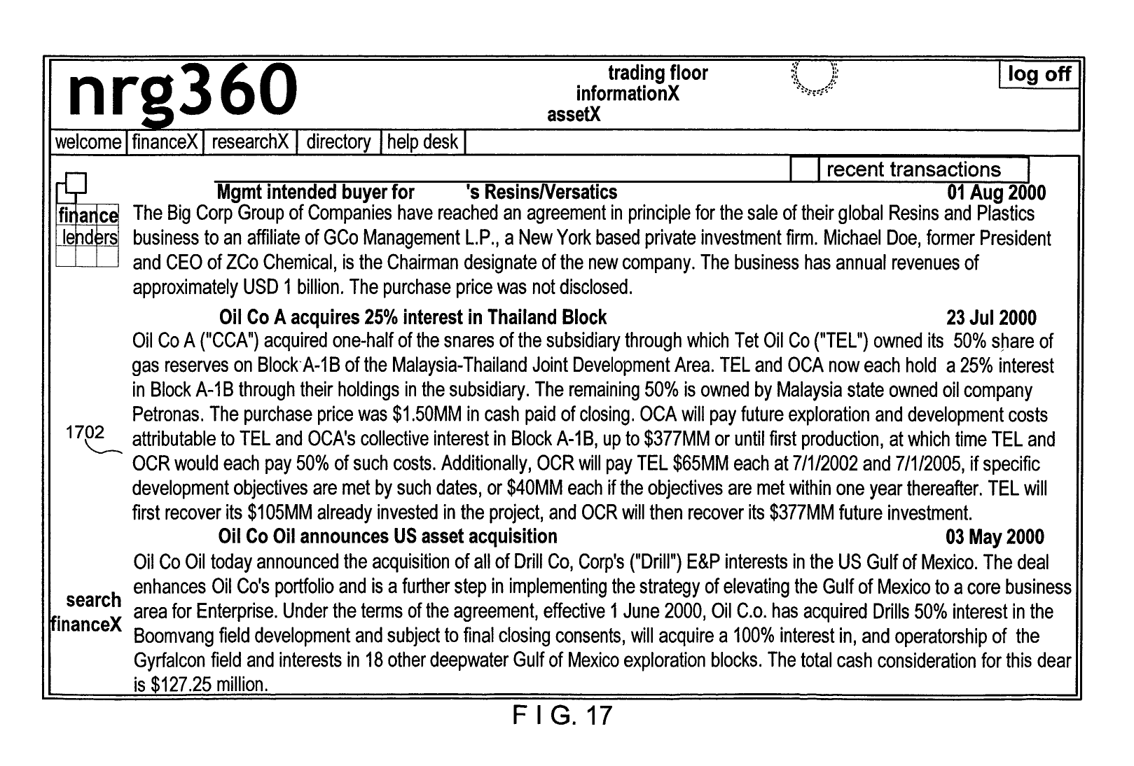

The interface of the finance exchange can also display certain news items and reports of recent transactions. In this example and as shown in FIG. 17, the user sees a report 1702 of a recent transaction relevant to the transaction in which he or she is participating (in step 720 of FIG. 7). The user can further explore the issues raised by the transaction report 702 by seeking additional information on a communications hub (step 722). The communications hub 344 can link all of the exchanges on the system, and can be accessible from anywhere within the system. The hub 344 provides electronic communications services among participants in the various exchanges. The communications services can be facilitated by secured public and private IP services. Security can be enhanced by the use of particular measures such as, for example, cryptography and secure protocols. The communications hub 344 can include features such as file transfer, secure e-mail, creation of virtual work groups, on-line messaging and conferencing, collaborative directory services, fax communication, and alerts to notify the user of incoming messages. The on-line messaging and conferencing can be used to allow parties to enter a virtual “chat room.”

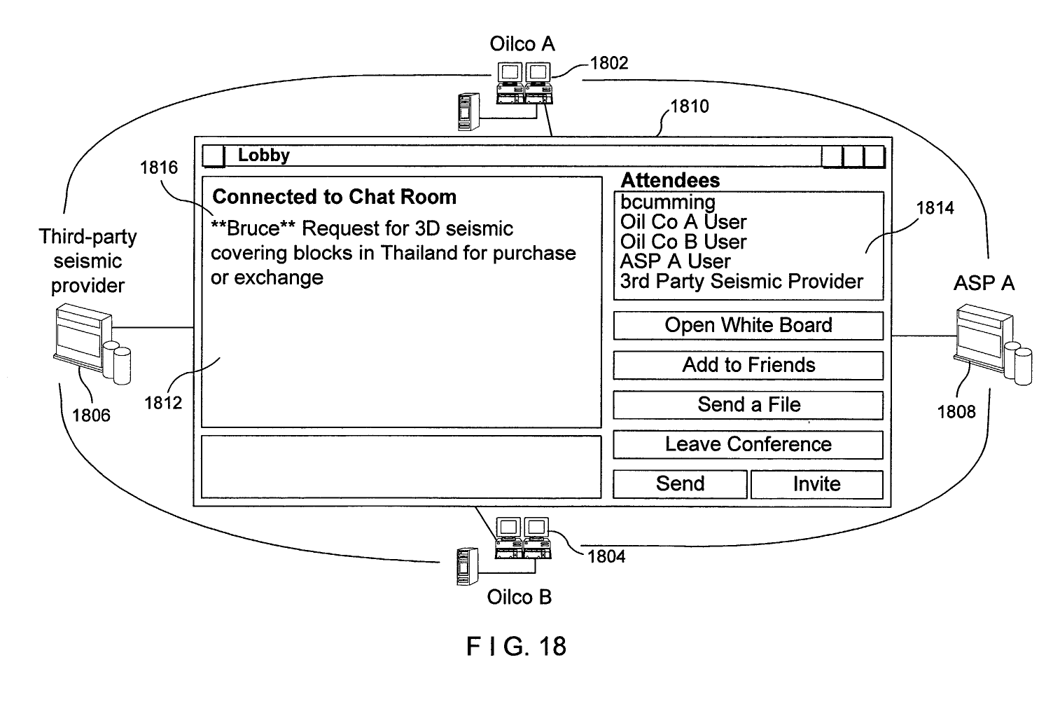

FIG. 18 illustrates an example of a virtual work group defined by the user. In addition to the user, the work group of this example includes two oil companies 1802 and 1804, a third-party seismic data provider 1806, and an application service provider 1808. However, the work group can also include other parties such as, for example, other users or entities bidding on the asset. In this example, members of the work group are connected to a chat room which enables an on-line conferencing to take place. A display window 1810 can include a text box 1814 listing the attendees of the chat room, and a text box 1812 for displaying messages sent into the chat room by various attendees. The system of the present invention can be configured to allow messages to be sent in “real-time”—i.e., with minimal delay. In this example, the user makes a request 1816 for seismic data that is related to the asset he or she is considering purchasing.

In response to the request 1816 for seismic data, a work group member such as the third-party seismic provider 1806 can offer information which can be bought or swapped. The information can be offered on an information exchange in accordance with the present invention. For example, the user can receive an offer of information for sale, or can receive an offer for an off-line negotiation between the user and the information provider.

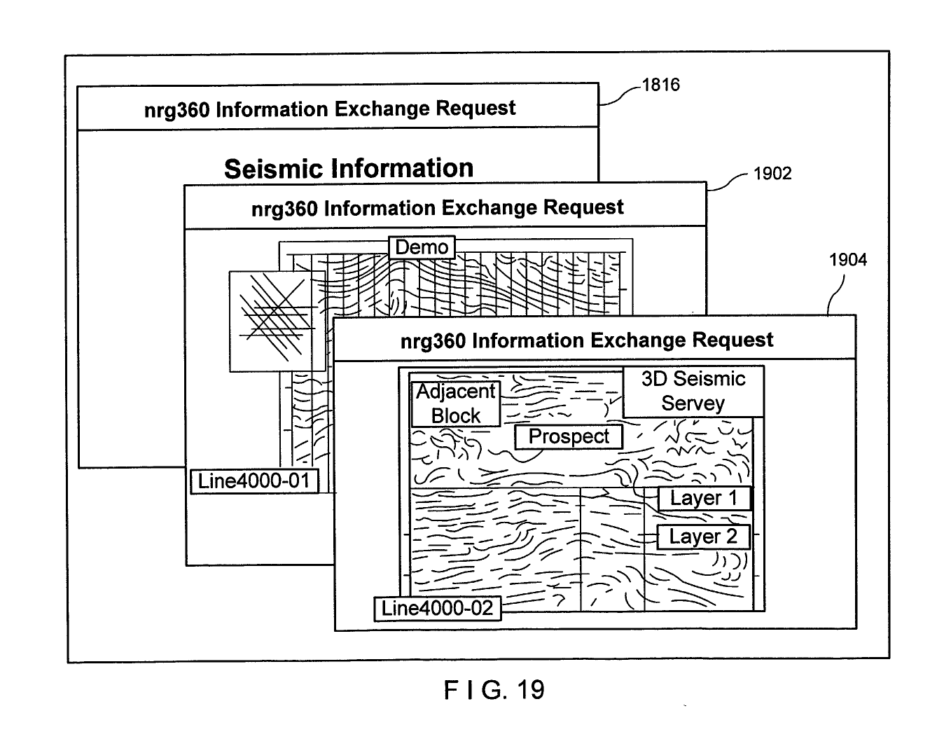

In this example, the user accepts an offer, and purchases the data. Upon receiving the data (step 724 of FIG. 7), the user can reinterpret the data using third-party services such as visualization services (step 726). For example, the data can be sent to the third-party service for analysis and interpretation, whereupon the results are then returned to the user/bidder. The results can be displayed on the user's computer screen. For example, as illustrated in FIG. 19, the results can be displayed in the form of images 1902 and 1904.

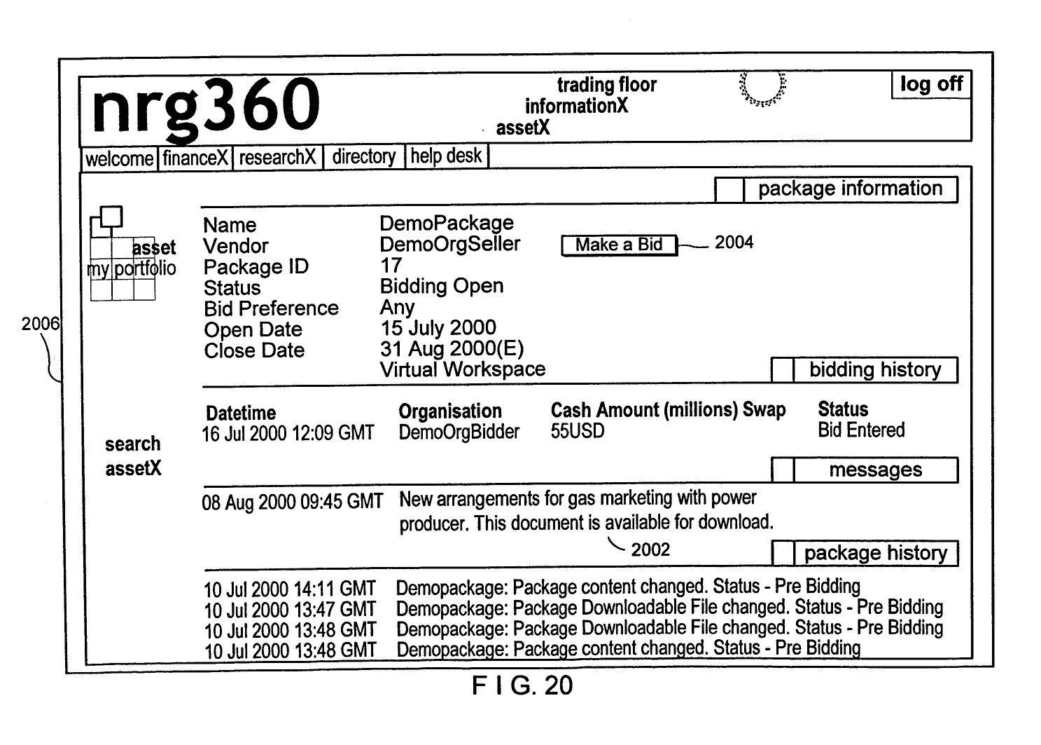

In addition, it is possible for the seller of the asset to inform the bidders about new data obtained by the seller (step 708 of FIG. 7). The seller can inform the bidders about the new data by transmitting the data for display on the bidders' respective asset exchange display pages, as illustrated in FIG. 20. For example, an indication that new information is available can be provided in the form of a brief description 2002 of the information. A bidder can access the seller-provided data in his virtual workspace (step 710), and can process the data using software such as, for example, third-party software based on a third-party economic model (step 728). Based upon the results obtained by the analysis in step 728, the bidder can revise his or her bid (step 712). Furthermore, a potential purchaser can contact the seller to request information about the asset.

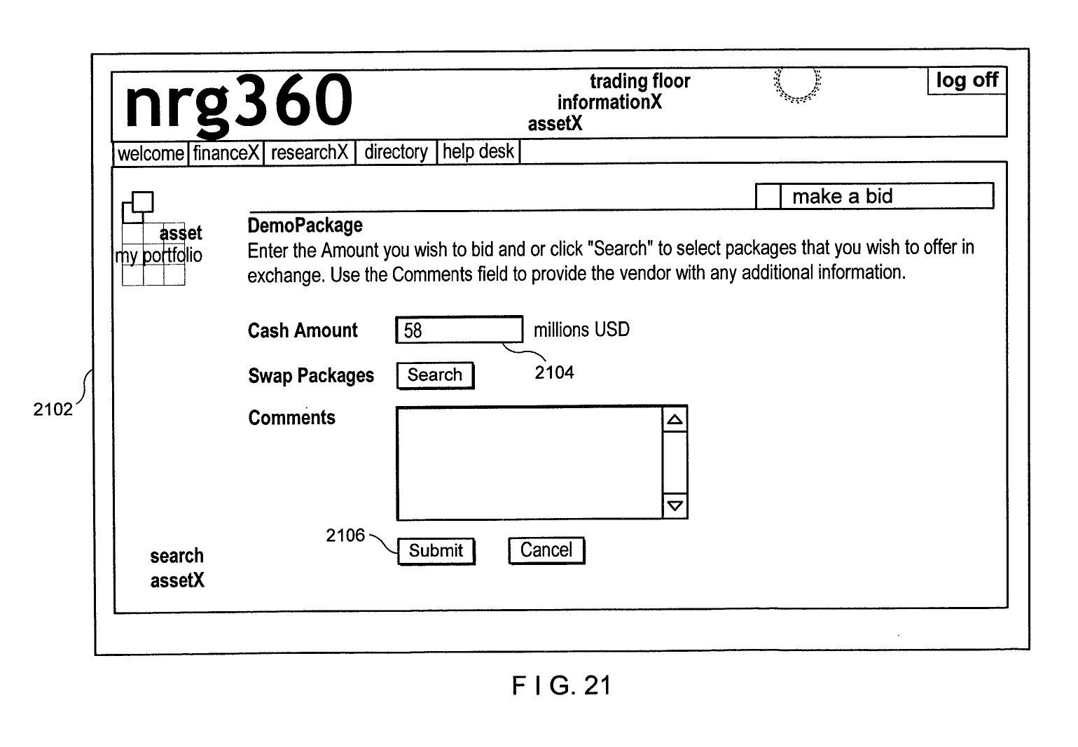

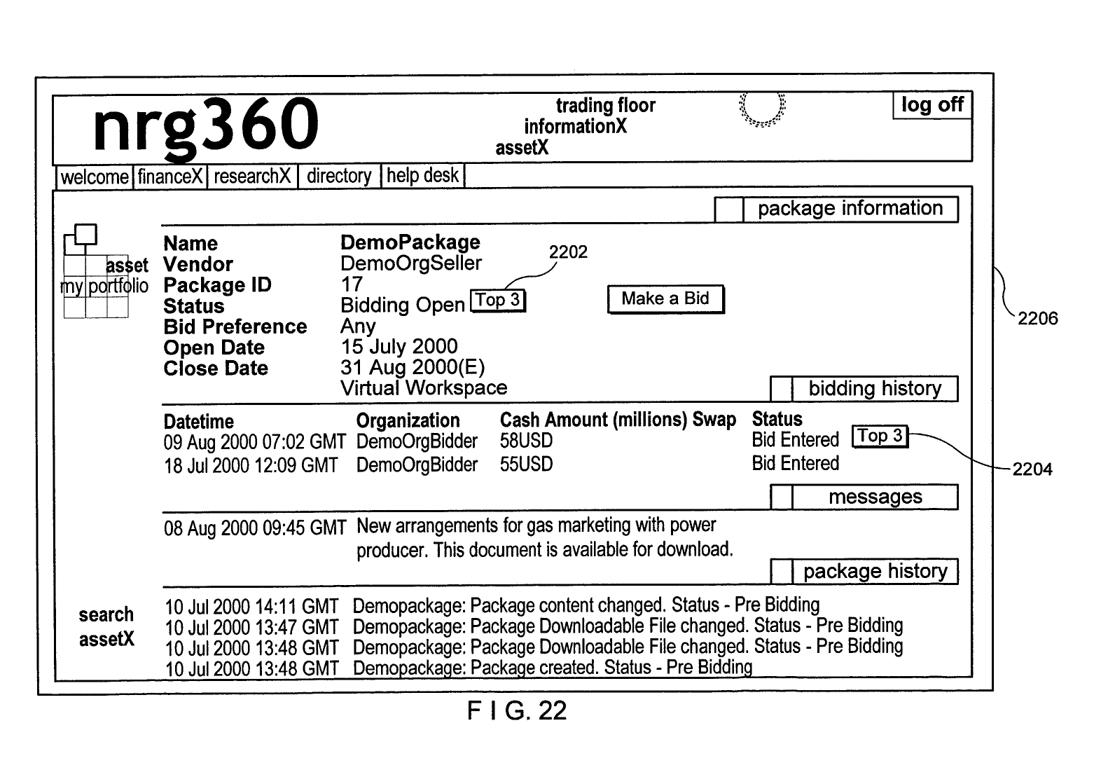

In addition, as illustrated in FIG. 20, the display screen 2006 associated with a particular asset can enable the user to access a bidding display by clicking on a button 2004. An example of such a bidding display is provided in FIG. 21. The display 2102 can provide a text box 2104 which allows the user to enter an amount of a new bid or a revised bid. The bid can be submitted by clicking on a button 2106, whereupon the user can be returned to the display page 2006 containing information about the asset package upon which the user is bidding. In this example, the user submitted a revised bid, which is now among the top three bids, as indicated by “top three” indicator symbols 2202 and 2204 (as shown in FIG. 22).

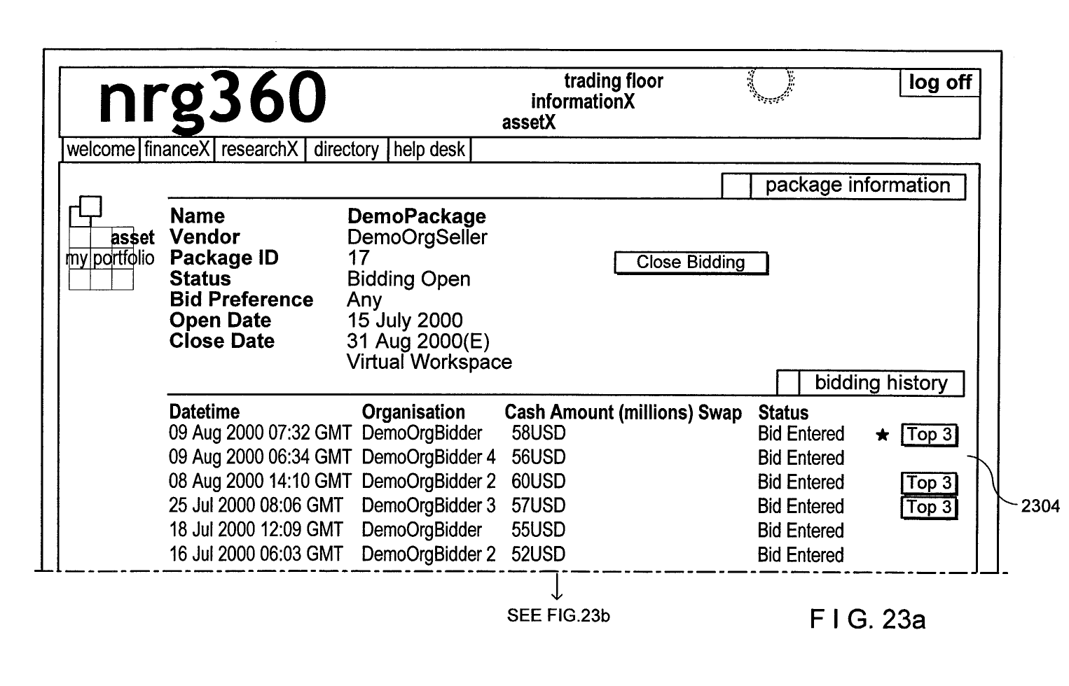

It is to be noted that the above-described features of the present invention (including the transaction execution and management support, the on-line data room, the asset exchange, the finance exchange, and the information exchange) can be made available to sellers and buyers of assets. An example of the asset exchange display screen which can be presented to an asset seller in accordance with the present invention is illustrated in FIG. 23. The display screen 2308 can include a package history section 2306 listing relevant events in the history of the development and selling of the package, a bidding history section 2304 listing bids which have been made upon the package, and a message section 2302 which enables the seller to send messages to one or more bidders 2310.

In order to facilitate use of the system, a human-operated, telephone-based help desk service can be provided. Such a service can receive, log, and manage reports of problems with the system, and can receive information requests from existing and/or potential users.

In addition, an on-line help desk can be provided. The on-line help desk can be accessed via a hyperlink provided on one or more of the display screens of the system. The on-line help desk can provide descriptions of relevant terms and concepts, and can include an additional hyperlink for connecting a user to an e-mail editor which enables the user to send one or more electronic messages to a “webmaster” (i.e., a web site administrator) or other personnel. The on-line help desk can also provide the telephone number of the aforementioned human-operated help desk service.

In accordance with the present invention, fees can be changed for use of the system and the various services. For example, a periodic (e.g., monthly, quarterly, and/or yearly) subscription fee can be charged for the use of the system, process and services. However, for promotional purposes, it may be desirable to forego (either temporarily or permanently) the subscription fee, possibly in general or with respect to selected, highly desirable potential participants. For the asset exchange service, the transaction fee can include a listings fee, a data room fee, and a transaction execution fee. A listings fee can comprise a monthly rental fee for listing an asset of any size on the system.

A data room fee can comprise a flat fee for setting up an on-line data room, which can range from a smaller fee for small assets to a larger fee for large assets. In addition, a monthly operating fee can be charged for data room maintenance. Optionally, the pricing structure can be configured such that the companies using the data room service do not pay a separate listings fee.

A transaction execution fee can comprise a success-based fee which can be charged on the transactions using the full functionality including the auction and transaction management services. The transaction execution fee can be payable upon transaction completion, and can be limited to a first maximum fraction of the net asset value for small transactions and a second maximum fraction of the net asset value for large transactions. As an example, which is provided for purposes of illustration and is not meant to imply any specific bounds to the possible ranges of the aforementioned fractions, the first maximum fraction can be set to a value of 0.6% and the second maximum fraction can be set to a value of 0.4%. In addition, other values of these maximum fractions can be used; the choice of values can vary greatly according to the particular transaction and the surrounding circumstances.

Optionally, the pricing structure can be configured such that the fee charged from the users (independent of usage level and duration) is limited to a maximum fee.

For the finance exchange service, revenue can be generated from a combination of the subscription fee (which can be paid by the financial institution) and revenue sharing with the financial services providers. For example, the financial institutions can be charged on a subscription fee basis. In addition, the pricing structure can be configured such that the financial institutions are not required to pay the subscription fees during an initial period, e.g., the first year of operations.

The revenue sharing model can evolve with time. For example, once a particular threshold of activity has been reached, a revenue sharing fee can be charged for capital raising and risk management services sourced through the site. The pricing structure can be configured such that no revenue sharing fees are charged during an initial period, e.g., the first three years.

In addition, fees can be charged for access to the infrastructure of the system, including the asset exchange, the finance exchange, the knowledge exchange, the network, and the value-added analysis. The pricing structure can be configured such that the smaller companies are charged less, and the larger companies are charged more.

The fees payable by the user can be structured either as a subscription package or on a pay-per-use basis. Optionally, these fees may be waived during an initial period of operation. In addition, the precise structure of the fee model can evolve with the business.

With regard to decision support services such as content and geo-technical applications, a web-based delivery method and a pay-per-use pricing model can be used. Optionally, the system and process in accordance with the present invention can provide a distribution platform for the third-party content, applications, and services, and can also provide an integrated customer management and billing system for these features. The customer management and billing system facilitates the delivery of services from the third-party ASPs. In addition, the fees can be structured using a revenue sharing model based on the revenues generated by participants' usage of the decision support services.

The present invention is beneficial for the exchange of assets valued at e.g., less than $200 million because the sales process for smaller assets can be relatively easily standardized, with tangible benefits flowing from the greater liquidity of the market segment. The sub-$200 million market can be divided into three brackets, as discussed below.

Property acquisitions smaller than $10 million typically include non-producing and end-of-life assets, and also include exploration farm-ins/farm-outs. The smaller companies are typically active traders of producing and end-of-life assets, whereas the major companies and larger independent companies usually participate as the sellers. A range of companies (from the smaller players to the larger independent companies) carry out the exploration farm-ins and farm-outs. Approximately $4-8 billion of these assets are traded each year.

Property acquisitions between $10-50 million typically include end-of-life and non-core assets. The buyers of these assets are usually the small independent companies, with the larger companies on the selling side. The strategic transactions typically involve the major and supermajor companies selling to the large independent companies. Approximately $8-14 billion of these assets are traded each year.

Property acquisitions greater than $50 million typically include strategic acquisitions and divestitures. The major and supermajor companies often sell to the large independent companies through targeted marketing. Approximately $8-20 billion of these assets are traded each year.

Approximately 84% of the asset transaction market by value lies in the transactions smaller than $200 million, with the remaining 16% ascribed to the asset transactions with a value that is greater than $200 million.

It will be appreciated by those skilled in the art that the systems and processes shown in FIGS. 1-28 can be implemented using various standard computer platforms operating under the control of suitable software defined by FIGS. 1-28. In certain cases, dedicated computer hardware, such as a peripheral card which resides on the bus of a standard personal computer, may enhance the operational efficiency of the above methods.

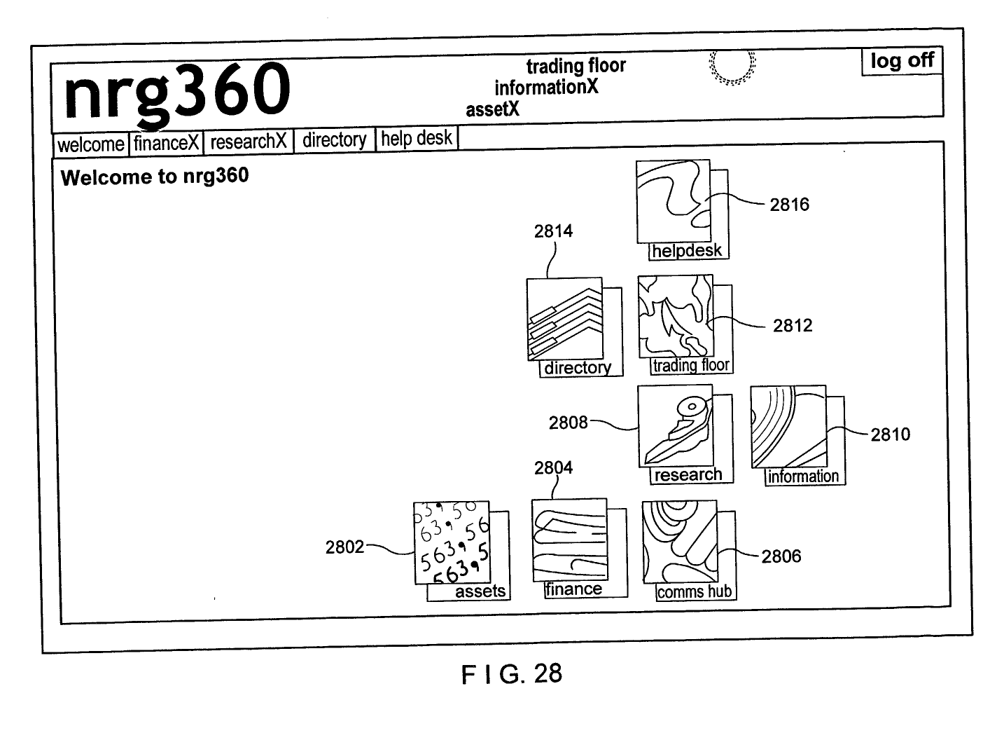

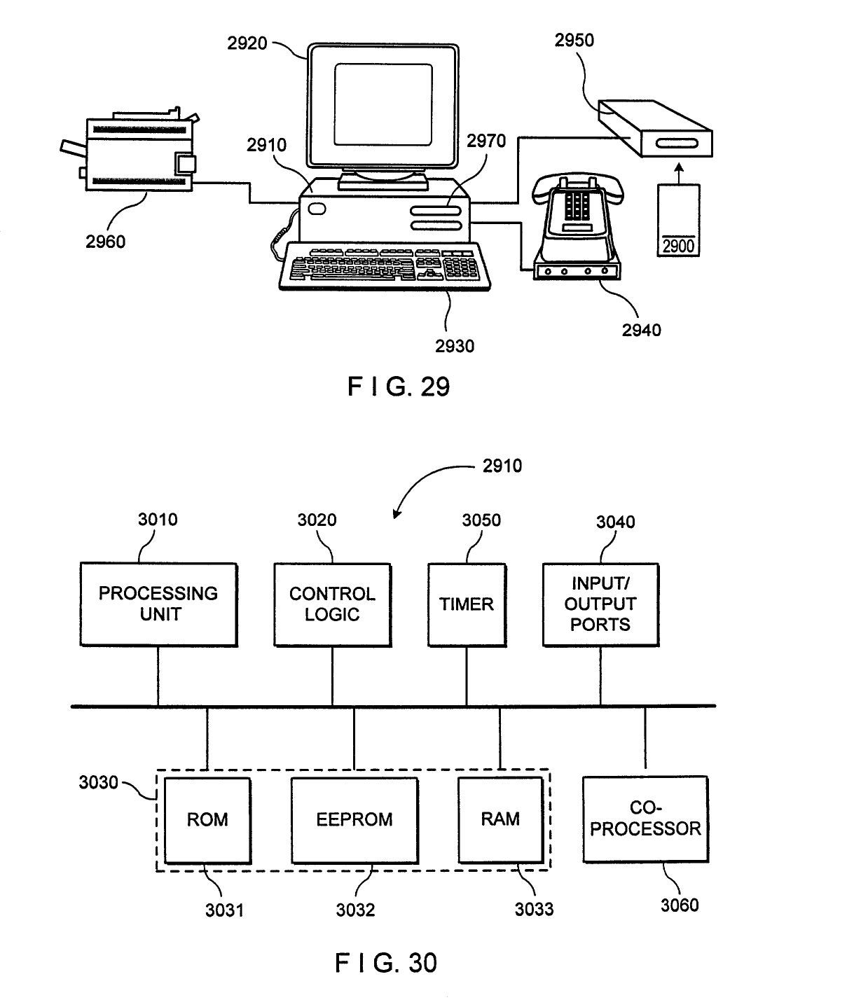

FIGS. 29 and 30 illustrate typical computer hardware suitable for practicing the present invention. Referring to FIG. 29, the computer system includes a computer section 2910, a display 2920, a keyboard 2930, and a communications peripheral device 2940 (e.g., a modem). The system may also include other input devices and a printer 2960. The computer system generally includes one or more disk drives 2970 which can read and/or write to computer readable media, such as magnetic media (i.e., diskettes) or optical media (i.e., CD-ROMS) for storing data and application software. While not shown for the sake of clarity, other input devices, such as a digital pointer (e.g., a “mouse”) and the like may also be included.

FIG. 30 is a functional block diagram which further illustrates the computer section 2910 of FIG. 29. The computer section 2910 generally includes a processing unit 3010, a control logic arrangement 3020 and a memory unit 3030. Preferably, the computer section 2910 can also include a timer 3050 and input/output ports 3040. The computer section 2910 can also include a co-processor 3060, depending on the microprocessor used in the processing unit. The control logic arrangement 3020 provides (in conjunction with processing unit 3010) the control necessary to handle communications between the memory unit 3030 and input/output ports 3040. A timer 3050 provides a timing reference signal for the processing unit 3010 and the control logic arrangement 3020. The co-processor 3060 provides an enhanced ability to perform complex computations in real time, such as those which are generally used in cryptographic algorithms.

The memory unit 3030 may include different types of memory, such as volatile and non-volatile memory and read-only and programmable memory. For example, as shown in FIG. 30, the memory unit 3030 may include read-only memory (ROM) 3031, electrically erasable programmable read-only memory (EEPROM) 3032, and random-access memory (RAM) 3033. Different computer processors, memory configurations, data structures and the like can be used to practice the present invention, and the invention is not limited to a specific platform.

Although the present invention has been described in connection with specific exemplary embodiments, it should be understood that various changes, substitutions and alterations can be made to the disclosed embodiments without departing from the spirit and scope of the invention as set forth in the appended claims.

What is claimed is:

1. A method for providing an exchange service, comprising the steps of:
providing an asset exchange service configured to transmit, using a network, asset-related information between a first party and a second party, the first party including at least one of a first potential asset transferor and a first potential asset transferee, and the second party including at least one of a second potential asset transferor and a second potential asset transferee; and
providing a finance exchange service configured to enable at least one of the first party and the second party to at least one of:
negotiate for at least one financing-related transaction with at least one financial institution; and
execute the at least one financing-related transaction.

2. A method according to claim 1, further comprising the step of providing at least one interface configured to communicate with the first party, wherein the at least one interface is used to perform the steps of providing the asset exchange service and providing the finance exchange service.

3. A method according to claim 1, wherein the asset-related information comprises information about a physical characteristic of an asset.

4. A method according to claim 3, wherein the physical characteristic of the asset comprises a geological characteristic of the asset.

5. A method according to claim 3, wherein the asset comprises a real estate asset, and wherein the physical characteristic of the asset relates to a natural resource which can be harvested from the real estate asset.

6. A method according to claim 5, wherein the natural resource comprises a mineral.

7. A method according to claim 6, wherein the mineral comprises at least one of oil and gas.

8. A method according to claim 1, wherein the asset-related information comprises information about a legal characteristic of an asset.

9. A method according to claim 8, wherein the legal characteristic of the asset comprises an ownership status of the asset.

10. A method according to claim 8, wherein the legal characteristic of the asset comprises a status regarding a security interest in the asset.

11. A method according to claim 1, wherein the asset-related information comprises information about a financial characteristic of an asset.

12. A method according to claim 11, wherein the financial characteristic of the asset comprises a monetary value of the asset.

13. A method according to claim 1, wherein the asset-related information comprises at least one bid.

14. A method according to claim 13, wherein the at least one bid comprises a revised bid.

15. A method according to claim 1, wherein the asset-related information comprises information about a status regarding at least one bid.

16. A method according to claim 1, wherein the asset-related information comprises a request for information regarding at least one asset available for sale or barter.

17. A method according to claim 1, wherein the asset exchange service is configured to execute a transaction involving at least one interest in at least one asset, upon a command of at least one of the first party and the second party.

18. A method according to claim 17, wherein the transaction comprises a transfer of the at least one interest between the first party and the second party.

19. A method according to claim 17, wherein the transaction comprises at least one of a sale of the at least one asset, a purchase of the at least one asset, and a barter involving the at least one asset.

20. A method according to claim 1, wherein the asset exchange service is configured to store information related to an amount of interest generated by at least one asset and expressed by at least one of a potential buyer and a potential barterer.

21. A method according to claim 1, wherein the asset exchange service is configured to enable at least one of a buyer and a seller to transmit a message to at least one of a selected bidder and a selected potential bidder.

22. A method according to claim 1, wherein the financing-related transaction relates to a financing of at least one particular transaction involving at least one asset.

23. A method according to claim 22, wherein the at least one particular transaction is executed using the asset exchange service.

24. A method according to claim 23, wherein the at least one particular transaction comprises a purchase of the at least one asset between the first party and the second party, and wherein the financing-related transaction comprises a loan used to finance the purchase.

25. A method according to claim 1, wherein the at least one financing-related transaction comprises at least one risk management transaction which is structured to manage a risk associated with at least one asset.

26. A method according to claim 1, wherein the finance exchange service is configured to enable the at least one financial institution to transmit a loan offer.

27. A method according to claim 26, wherein the loan offer is transmitted to at least one of the first party and the second party.

28. A method according to claim 26, wherein the loan offer is tailored for a selected offeree.

29. A method according to claim 26, wherein the loan offer is tailored for a selected asset.

30. A method according to claim 26, wherein the loan offer is provided in response to a request for an offer, and wherein the request is made by at least one of the first party and the second party.

31. A method according to claim 1, further comprising the steps of:
providing at least one interface configured to communicate with the first party; and
using the at least one interface to provide a virtual data room containing selected data.

32. A method according to claim 31, wherein the data room is accessible to a restricted set of parties.

33. A method according to claim 32, wherein the restricted set of parties comprises a set of financial institutions.

34. A method according to claim 1, wherein the finance exchange service is configured to provide at least one financial service which is customized for a selected one of the first party and the second party.

35. A method according to claim 1, further comprising the step of providing an information exchange service configured to enable the first party to obtain selected decision support information, the selected decision support information being relevant to at least one decision regarding whether to engage in at least one transaction involving at least one asset.

36. A method according to claim 35, wherein the information exchange service is configured to enable the first party to select the selected decision support information from available decision support information.

37. A method according to claim 36, wherein the available decision support information includes technical information related to at least one of geology and a natural resource.

38. A method according to claim 37, wherein the technical information is related to an acquisition of oil-producing property.

39. A method according to claim 37, wherein the technical information is related to an acquisition of gas-producing property.

40. A method according to claim 36, wherein the available decision support information includes information supplied by a third party.

41. A method according to claim 36, wherein the information exchange service includes a search engine configured to enable the first party to perform a search upon the available decision support information, and wherein the search finds the selected decision support information.

42. A method according to claim 36, further comprising the steps of:
monitoring a usage of the available decision support information, wherein the usage is by the first party; and
based on results obtained from the monitoring step, adjusting a content of the available decision support information so that the content is matched to the usage.

43. A method according to claim 36, further comprising the steps of:
enabling the first party to express an interest in the at least one asset by using at least one interface to select the at least one asset; and
if the first party expresses the interest in the at least one asset, selecting, for an inclusion in the available decision support information, information having heightened relevance to the at least one transaction involving the at least one asset.

44. A method according to claim 43, further comprising the step of:
if the first party expresses the interest in the at least one asset, enabling the first party to access analytical software configured to produce the information having heightened relevance.

45. A method according to claim 44, wherein the analytical software includes software provided by a third party.

46. A method according to claim 35, wherein the information exchange service is further configured to enable the first party to access analytical software configured to produce the selected decision support information.

47. A method according to claim 35, wherein the information exchange service is configured to execute an information transaction involving the selected decision support information, the information transaction being executed upon a command of at least one of the first party and an information provider.

48. A method according to claim 47, wherein the information transaction comprises at least one of a barter and a sale.

49. A method according to claim 1, further comprising the steps of:
providing at least one interface configured to communicate with the first party; and
using the at least one interface to provide a virtual workspace which includes a plurality of digital links, the digital links enabling the first party to access the asset exchange service and the finance exchange service.

50. A method according to claim 1, further comprising the step of providing a communications hub which is configured to transmit data between the first party and the second party, the communications hub being further configured to transmit data between the first party and the at least one financial institution.

51. A method according to claim 50, further comprising the step of providing an information exchange service that is configured to enable the first party to obtain selected decision support information, the selected decision support information being relevant to at least one decision regarding whether to engage in at least one transaction involving at least one asset, wherein the communications hub is further configured to transmit data between the first party and at least one provider providing the first party with access to at least one of information and software via the information exchange service.

52. A method according to claim 50, wherein the communications hub is further configured to support at least one user-defined work group comprising a plurality of members, and wherein the communications hub is further configured to transmit data among the plurality of members, using at least one of cryptography and a secure protocol.

53. A method according to claim 50, wherein the communications hub is further configured to support a secure transmission of electronic mail between the first party and the second party, and between the first party and the at least one financial institution.

54. A method according to claim 50, wherein the communications hub is further configured to support real-time message communication between the first party and the second party, and between the first party and the at least one financial institution.

55. A method according to claim 54, wherein the real-time message communication includes conferencing among at least three parties.

56. An apparatus for providing an exchange service, comprising:
a processor controlled by a set of instructions which directs the processor to:
provide an asset exchange service configured to transmit, using a network, asset-related information between a first party and a second party, the first party including at least one of a first potential asset transferor and a first potential asset transferee, and the second party including at least one of a second potential asset transferor and a second potential asset transferee, and
provide a finance exchange service configured to enable at least one of the first party and the second party to at least one of:
negotiate for at least one financing-related transaction with at least one financial institution; and
execute the at least one financing-related transaction.

57. An apparatus as recited in claim 56, wherein the set of instructions further directs the processor to provide at least one interface configured to communicate with the first party, wherein the processor uses the at least one interface to provide the asset exchange service and the finance exchange service.

58. An apparatus as recited in claim 56, wherein the asset-related information comprises information about a physical characteristic of an asset.

59. An apparatus as recited in claim 58, wherein the physical characteristic of the asset comprises a geological characteristic of the asset.

60. An apparatus as recited in claim 58, wherein the asset comprises a real estate asset, and wherein the physical characteristic of the asset relates to a natural resource which can be harvested from the real estate asset.

61. An apparatus as recited in claim 60, wherein the natural resource comprises a mineral.

62. An apparatus as recited in claim 61, wherein the mineral comprises at least one of oil and gas.

63. An apparatus as recited in claim 56, wherein the asset-related information comprises information about a legal characteristic of an asset.

64. An apparatus as recited in claim 63, wherein the legal characteristic of the asset comprises an ownership status of the asset.

65. An apparatus as recited in claim 63, wherein the legal characteristic of the asset comprises a status regarding a security interest in the asset.

66. An apparatus as recited in claim 56, wherein the asset-related information comprises information about a financial characteristic of an asset.

67. An apparatus as recited in claim 66, wherein the financial characteristic of the asset comprises a monetary value of the asset.

68. An apparatus as recited in claim 56, wherein the asset-related information comprises at least one bid.

69. An apparatus as recited in claim 68, wherein the at least one bid comprises a revised bid.

70. An apparatus as recited in claim 56, wherein the asset-related information comprises information about a status regarding at least one bid.

71. An apparatus as recited in claim 56, wherein the asset-related information comprises a request for information regarding at least one asset available for sale or barter.

72. An apparatus as recited in claim 56, wherein the asset exchange service is configured to execute a transaction involving at least one interest in at least one asset, upon a command of at least one of the first party and the second party.

73. An apparatus as recited in claim 72, wherein the transaction comprises a transfer of the at least one interest between the first party and the second party.

74. An apparatus as recited in claim 72, wherein the transaction comprises at least one of a sale of the at least one asset, a purchase of the at least one asset, and a barter involving the at least one asset.

75. An apparatus as recited in claim 56, further comprising a computer-readable medium in communication with the processor, wherein the asset exchange service is configured to store, in the computer-readable medium, information related to an amount of interest generated by at least one asset and expressed by at least one of a potential buyer and a potential barterer.

76. An apparatus as recited in claim 56, wherein the asset exchange service is configured to enable at least one of a buyer and a seller to transmit a message to at least one of a selected bidder and a selected potential bidder.

77. An apparatus as recited in claim 56, wherein the financing-related transaction relates to financing of at least one particular transaction involving at least one asset.

78. An apparatus as recited in claim 77, wherein the at least one particular transaction is executed using the asset exchange service.

79. An apparatus as recited in claim 78, wherein the at least one particular transaction comprises a purchase of the at least one asset between the first party and the second party, and wherein the financing-related transaction comprises a loan used to finance the purchase.

80. An apparatus as recited in claim 56, wherein the at least one financing-related transaction comprises at least one risk management transaction which is structured to manage a risk associated with at least one asset.

81. An apparatus as recited in claim 56, wherein the finance exchange service is configured to enable the at least one financial institution to transmit a loan offer.

82. An apparatus as recited in claim 81, wherein the loan offer is transmitted to at least one of the first party and the second party.

83. An apparatus as recited in claim 81, wherein the loan offer is tailored for a selected offeree.

84. An apparatus as recited in claim 81, wherein the loan offer is tailored for a selected asset.

85. An apparatus as recited in claim 81, wherein the loan offer is provided in response to a request for an offer, and wherein the request is made by at least one of the first party and the second party.

86. An apparatus as recited in claim 56, wherein the set of instructions further directs the processor to:
provide at least one interface configured to communicate with the first party; and
use the at least one interface to provide a virtual data room containing selected data.

87. An apparatus as recited in claim 86, wherein the data room is accessible to a restricted set of parties.

88. An apparatus as recited in claim 87, wherein the restricted set of parties comprises a set of financial institutions.

89. An apparatus as recited in claim 56, wherein the finance exchange service is configured to provide at least one financial service which is customized for a selected one of the first party and the second party.

90. An apparatus as recited in claim 56, wherein the set of instructions further directs the processor to provide an information exchange service configured to enable the first party to obtain selected decision support information, the selected decision support information being relevant to at least one decision regarding whether to engage in at least one transaction involving at least one asset.

91. An apparatus as recited in claim 90, wherein the information exchange service is configured to enable the first party to select the selected decision support information from available decision support information.

92. An apparatus as recited in claim 91, wherein the available decision support information includes technical information related to at least one of geology and a natural resource.

93. An apparatus as recited in claim 92, wherein the technical information is related to an acquisition of oil-producing property.

94. An apparatus as recited in claim 92, wherein the technical information is related to an acquisition of gas-producing property.

95. An apparatus as recited in claim 91, wherein the available decision support information includes information supplied by a third party.

96. An apparatus as recited in claim 91, wherein the information exchange service includes a search engine configured to enable the first party to perform a search upon the available decision support information, and wherein the search finds the selected decision support information.

97. An apparatus as recited in claim 91, wherein the set of instructions further directs the processor to perform the steps of:
monitoring a usage of the available decision support information, wherein the usage is by the first party; and
based on results obtained from the monitoring step, adjusting a content of the available decision support information so that the content is matched to the usage.

98. An apparatus as recited in claim 91, wherein the set of instructions further directs the processor to perform the steps of:
enabling the first party to express an interest in the at least one asset by using at least one interface to select the at least one asset; and
if the first party expresses the interest in the at least one asset, selecting, for an inclusion in the available decision support information, information having heightened relevance to the at least one transaction involving the at least one asset.

99. An apparatus as recited in claim 98, wherein, if the first party expresses the interest in the at least one asset, the set of instructions further directs the processor to enable the first party to access analytical software configured to produce the information having heightened relevance.

100. An apparatus as recited in claim 99, wherein the analytical software includes software provided by a third party.

101. An apparatus as recited in claim 90, wherein the information exchange service is further configured to enable the first party to access analytical software configured to produce the selected decision support information.

102. An apparatus as recited in claim 90, wherein the information exchange service is configured to execute an information transaction involving the selected decision support information, the information transaction being executed upon a command of at least one of the first party and an information provider.

103. An apparatus as recited in claim 102, wherein the information transaction comprises at least one of a barter and a sale.

104. An apparatus as recited in claim 56, wherein the set of instructions further directs the processor to:
provide at least one interface configured to communicate with the first party; and
use the at least one interface to provide a virtual workspace which includes a plurality of digital links, the digital links enabling the first party to access the asset exchange service and the finance exchange service.

105. An apparatus as recited in claim 56, wherein the processor is in communication with a communications hub, wherein the communications hub is configured to transmit data between the first party and the second party, and wherein the communications hub is further configured to transmit data between the first party and the at least one financial institution.

106. An apparatus as recited in claim 105, wherein the set of instructions further directs the processor to provide an information exchange service that is configured to enable the first party to obtain selected decision support information, the selected decision support information being relevant to at least one decision regarding whether to engage in at least one transaction involving at least one asset, wherein the communications hub is further configured to transmit data between the first party and at least one provider providing the first party with access to at least one of information and software via the information exchange service.

107. An apparatus as recited in claim 105, wherein the communications hub is further configured to support at least one user-defined work group comprising a plurality of members, and wherein the communications hub is further configured to transmit data among the plurality of members, using at least one of cryptography and a secure protocol.

108. An apparatus as recited in claim 105, wherein the communications hub is further configured to support a secure transmission of electronic mail between the first party and the second party, and between the first party and the at least one financial institution.

109. An apparatus as recited in claim 105, wherein the communications hub is further configured to support real-time message communication between the first party and the second party, and between the first party and the at least one financial institution.

110. An apparatus as recited in claim 109, wherein the real-time message communication includes conferencing among at least three parties.
